(19) United States
(12) Patent Application Publication
(10) Pub. No.: US 2026/0289912 A1
(43) Pub. Date: Sep. 24, 2026

(54) VIDEO COMMUNICATION METHOD AND SYSTEM

(71) Applicant: POMMELHORSE LTD, Edinburgh (GB)

(72) Inventors: Seyed Danesh, Edinburgh (GB); Michael Garbutt, Edinburgh (GB)

(21) Appl. No.: 19/471,792

(22) PCT Filed: Mar. 11, 2024
(86) PCT No.: PCT/GB2024/050654

§ 371 Date: Oct. 2, 2025

(30) Foreign Application Priority Data
Apr. 4, 2023 (GB) 2305002.4

(51) Int. Cl. G06T 19/00; G06T 7/70

(52) U.S. Cl. CPC G06T 19/00; G06T 7/70; G06T 2207/10016; G06T 2207/10024; G06T 2207/30196

(57) ABSTRACT

The present disclosure relates to methods, systems, computer programs and apparatus for video communication between a first user (801) and a second user (805). In one example, there is a method comprising receiving a first video stream comprising a first colour video made up of a first plurality of time-consecutive colour frames capturing a first scene that includes the first user (801) and receiving a second video stream comprising a second colour video made up of a second plurality of time-consecutive colour frames capturing a second scene that includes the second user (805). The method includes setting a position of a first virtual camera (811) based on: a location on a first display (802) at which the second colour video is displayed to the first user (801) and a location of the second user (805) within a second current colour frame of the second plurality of time-consecutive colour frames. A first transformed colour frame is generated using a first current colour frame of the first plurality of time-consecutive colour frames, wherein the first transformed colour frame appears to capture the first scene from the position of the first virtual camera (811).

### TECHNICAL FIELD

The present disclosure relates to a method, system, computer program and electronic devices for video communication between at least a first user and a second user.

### BACKGROUND

Live video streams are increasingly used to facilitate human-to-human interaction from remote locations, for example for video calls, video conferencing, video streaming purposes. In particular, a first person (e.g. a streamer) may use a video camera in combination with an electronic device to stream video data in real-time from a remote location to another person (e.g. a viewer), over a network. In many applications, the viewer may also be using a video camera in combination with an electronic device to stream video data in real-time back to the original streamer, hence achieving bi-directional video communication between the people. Video streams may be used in a variety of applications, including for work/productivity, in entertainment, healthcare, education or for remote assistance purposes.

It is understood that when communicating with and observing other people, humans use many visual cues such as eye contact, the position and movement of the eyes, and movement of head and face, to intentionally or unintentionally communicate emotions, feelings, and thoughts to one another. In general, in a face-to-face setting, these visual cues are used to facilitate communication and sharing of information between those involved. However, when digitally communicating over a video stream, the position of the video camera capturing the streamer has a significant impact on the viewers ability to gain information conveyed in the visual cues.

An ideal digital communication arrangement may be one that would mimic the experience of the streamer and the viewer being in the same physical space. However, the viewer may not receive a video stream resembling a view that they would have received if they were in the same physical space as the streamer. Rather, the video camera may be in a position that captures the streamer at an unnatural angle, which limits the quality of visual cues of the streamer that can be communicated to the viewer. As such, the position(s) of the video camera(s) can have a significant impact on the quality, productivity and usefulness of the interaction between the streamer and the viewer as they communicate.

In general, in a video call setting, the viewer may be more engaged with the streamer if the streamer appears to be looking directly at the viewer. This would require the streamer to look directly into the video camera when engaging the with viewer, which is often not practical. Further, for example in an education setting, or for remote healthcare or diagnosis, the viewer may not be receiving the ideal perspective of view of the streamer, to assist with education, learning, or diagnosis, since there are often physical constrains on where the video camera can be positioned in the streamer's environment. This can make it difficult for the streamer to appropriately engage the viewer in such scenarios.

### SUMMARY

In a first aspect of the disclosure, there is provided a method for video communication between a first user and a second user, the method comprising: receiving a first video stream comprising a first colour video made up of a first plurality of time-consecutive colour frames capturing a first scene that includes the first user, wherein the first colour video is captured by a first real camera; receiving a second video stream comprising a second colour video made up of a second plurality of time-consecutive colour frames capturing a second scene that includes the second user, wherein the second colour video is captured by a second real camera; setting a position of a first virtual camera based on: a location on a first display at which the second colour video is displayed to the first user; and a location of the second user within a second current colour frame of the second plurality of time-consecutive colour frames; generating a first transformed colour frame using a first current colour frame of the first plurality of time-consecutive colour frames, wherein the first transformed colour frame appears to capture the first scene from the position of the first virtual camera; and outputting the first transformed colour frame for display to the second user.

Setting the position of the first virtual camera may comprise: determining a location of an image of the second user on the first display; and setting the virtual camera based on the determined location.

Setting the position of the first virtual camera may be further based on a 3D position of the second user relative to a location at which the first transformed colour frame will be displayed to the second user on a second display.

Setting the position of the first virtual camera may comprise: determining the 3D position of the second user relative to the location at which the first transformed colour frame will be displayed on the second display using: the location of the second user within the second current colour frame; a depth of the second user from the second camera; the location at which the first transformed colour frame will be displayed on the second display; and a known position of the second real camera relative to the second display; and setting the position of the first virtual camera using: the location on the first display at which the second colour video is displayed to the first user; and the determined 3D position of the second user relative to the location at which the first transformed colour frame will be displayed on the second display.

The first virtual camera may be set at a 3D position that is behind the first display. Optionally, the 3D position of the first virtual camera behind the first display and relative to the location of the second colour video on the first display may correspond with the 3D position of the second user relative to the location at which the first transformed colour frame will be displayed on the second display.

The method may further comprise: setting a field of view of the first virtual camera based on: the 3D position of the second user relative to the location at which the first transformed colour frame will be displayed on the second display; and a size at which the first transformed colour frame will be displayed on the second display.

The method may further comprise determining the location of the second user within the second current colour frame comprises performing object recognition to identify at least one feature of the second user, wherein the at least one feature comprises at least one of: eyes; a nose; a mouth; ears.

Generating the first transformed colour frame may be based on the position of the virtual camera and a known position of the first camera.

The first transformed colour frame may be generated such that a location of the first user in the first transformed colour frame matches a location of the first user in the first current colour frame. The method may further comprise setting a rotation of the first virtual camera so that the location of the first user in the first transformed colour frame matches the location of the first user in the first current colour frame. The rotation of the first virtual camera may be set based on the position of the first virtual camera and a depth of the first user from the first display.

Generating the first transformed frame may comprise panning and/or cropping the first current colour frame so that the location of the first user in the first transformed colour frame matches the location of the first user in the first current colour frame.

Setting the position of the first virtual camera may be further based on a location of the second user within at least one preceding frame of the second plurality of time-consecutive colour frames, wherein the at least one preceding frame precedes the second current colour frame in the second plurality of time-consecutive colour frames.

The method may further comprise, responsive to a change in the location of the second colour video on the first display, setting an updated position of the first virtual camera based on: a new location of the second colour video on the first display; and the location of the second user within the second current colour frame. The method may further comprise setting the updated position of the first virtual camera further based on at least one previous position of the first virtual camera.

The method may further comprise: determining, based on the image content of the first current colour frame, whether at least one transformation adjustment condition is met; and if a transformation adjustment condition is met: adjusting the transformation applied to the first current colour frame in order to generate of the first transformed colour frame. The at least one transformation adjustment condition may comprise a pose condition, wherein determining whether the pose condition is met may comprise: determining a pose of the first user in the first current colour frame, wherein the pose comprises measures of pose in at least two dimensions; and if the magnitude of the determined pose is greater than the disablement threshold, the pose condition is met and the transformation is adjusted by disabling at least part of the transformation.

The method may further comprise comparing the determined pose to a reduction threshold that is smaller in magnitude than the disablement threshold, wherein if the magnitude of the determined pose is between the reduction threshold and the disablement threshold, the amount by which the first current colour frame is transformed to generate the first transformed colour frame is reduced compared with the transformation that would be applied if the magnitude of the determined pose were smaller than the reduction threshold.

The reduction threshold and the disablement threshold may define lower and upper limits of a range, and wherein the amount by which the transformation is reduced is dependent on where the magnitude of the determined pose is in the range. The amount by which the transformation is reduced may be proportional to where the magnitude of the determined pose is in the range.

The at least one transformation adjustment condition may comprise any one or more of: a proximity condition, wherein the proximity condition is met if a depth of the first user from the first camera is determined to be less than a proximity threshold; a distance condition, wherein the distance condition is met if a depth of the first user from the first camera is determined to be greater than a distance threshold.

The at least one transformation adjustment condition may comprise any one or more of: a compute resource condition, wherein the compute resource condition is met if a compute resource of a computing device on which at least part of the method is operating is determined to be less than a compute threshold; an object condition, wherein the object condition is met if object recognition performed on the first current colour frame identifies an object that is on a predetermined black list and/or if object recognition performed on the first current colour frame identifies an object that it cannot classify, wherein if the compute resource condition of the object condition are met, the transformation is adjusted by disabling the transformation and outputting the first current colour frame for display to the second user

The first current colour frame may comprise at least a first area and a second area, wherein the first area images a part of the first scene that is within a first depth range and the second area images a part of the first scene that is within a second depth range, and wherein generating the first transformed colour frame comprises separately transforming the first area and the second area, and wherein determining whether at least one transformation adjustment condition is met is based on the image content of the first current colour frame in the first area, and wherein adjusting the transformation comprises adjusting the transformation applied to the first area of the first current colour frame in order to generate the first transformed colour frame.

Adjusting the transformation applied to the first current colour frame may comprise: disabling the generation of the first transformed colour frame; and outputting the first current colour frame for display to the second user, rather than the first transformed colour frame.

The video communication between the first user and the second user may comprise data communication between a first electronic device associated with the first user and a second electronic device associated with the second user, wherein at least part of generating the first transformed colour frame is performed on the second electronic device.

Data communication from the first electronic device to the second electronic device may comprise the first video stream and data indicative of the location on the first display at which the second colour video is displayed relative to the position of the first real camera the first user.

Data communication from the first electronic device to the second electronic device may comprise a first current depth frame corresponding to the first current colour frame, wherein the first current depth frame is indicative of a depth at least part of the first scene from the first real camera.

The method may further comprise determining the first current depth frame using the first current colour frame and a third current depth frame captured by a third real camera that captures the first scene from a different position to that of the first real camera.

The video communication may be between the first user, the second user and a further user, the method further comprising: receiving a further video stream comprising a further colour video made up of a further plurality of time-consecutive colour frames capturing a further scene that includes the further user, wherein the further colour video is captured by a further real camera; setting a position of a further virtual camera based on: a location on the first display at which the further colour video is displayed to the first user; and a location of the further user within a further current colour frame of the further plurality of time-consecutive colour frames; generating a further transformed colour frame using the first current colour frame, wherein the further transformed colour frame appears to capture the first scene from the position of the further virtual camera; and outputting the further transformed colour frame for display to the further user.

The video communication between the first user, the second user and the third user may comprise data communication between a first electronic device associated with the first user, a second electronic device associated with the second user and a further electronic device associated with the third user, wherein data communication from the first electronic device to the second electronic device comprises: the first colour video; and data indicative of the location on the first display at which the second colour video is displayed relative to the position of the first real camera the first user, wherein at least part of generating the first transformed colour frame is performed on the second electronic device, and wherein data communication from the first electronic device to the further electronic device comprises: the first colour video; and data indicative of the location on the first display at which the further colour video is displayed relative to the position of the first real camera the first user, wherein at least part of generating the further transformed colour frame is performed on the further electronic device. The data communication from the first electronic device to the second electronic device may further comprise a first depth video comprising a first plurality of time-consecutive depth frames capturing the first scene. The data communication from the first electronic device to the third electronic device may further comprise the first depth video.

Setting the position of the first virtual camera and/or generating the first transformed current frame may be further based on a first current depth frame corresponding to the first current colour frame, wherein the first current depth frame is indicative of a depth at least part of the first scene from the first real camera. The method may further comprise generating the first current depth frame using the first current colour frame and a third current depth frame captured by a third real camera that captures the first scene from a different position to that of the first real camera.

In a second aspect of the present disclosure, there is further provided a method for video communication between a first user and a second user, the method comprising: receiving a first video stream comprising a first colour video made up of a first plurality of time-consecutive colour frames capturing a first scene that includes the first user, wherein the first colour video is captured by a first real camera; receiving a user input from the first user that sets a position of a first virtual camera; generating a first transformed colour frame using a first current colour frame of the first plurality of time-consecutive colour frames, wherein the first transformed colour frame appears to capture the first scene from the position of the first virtual camera; and outputting the first transformed colour frame for display to the second user.

The method may further comprise receiving a second video stream comprising a second colour video made up of a second plurality of time-consecutive colour frames capturing a second scene that includes the second user, wherein the second colour video is captured by a second real camera, wherein the second video stream is displayed to the first user on a first display, and wherein the user input from the first user indicates that the first virtual camera should be positioned to correspond with a location at which the second user appears on the first display.

In a third aspect of the present disclosure, there is provided a method for video communication between a first user and a second user, the method comprising: receiving a first video stream comprising a first colour video made up of a first plurality of time-consecutive colour frames capturing a first scene that includes the first user, wherein the first colour video is captured by a first real camera; the second user setting a position of a first virtual camera; generating a first transformed colour frame using a first current colour frame of the first plurality of time-consecutive colour frames, wherein the first transformed colour frame appears to capture the first scene from the position of the first virtual camera; and outputting the first transformed colour frame for display to the second user.

The method may further comprise receiving a second video stream comprising a second colour video made up of a second plurality of time-consecutive colour frames capturing a second scene that includes the second user, wherein the second colour video is captured by a second real camera, wherein the second video stream is displayed to the first user on a first display.

Each of the second and third aspects may optionally comprise any one or more of the following features:

Setting the position of the first virtual camera based at least in part on a location of an image of the second user on the first display. Determining the location of the second user may comprise performing object recognition to identify at least one feature of the second user, wherein the at least one feature comprises at least one of: eyes; a nose; a mouth; ears. The method may further comprise, responsive to a change in the location of the second colour video on the first display, setting an updated position of the first virtual camera based on: a new location of the second colour video on the first display; and the location of the second user within the second current colour frame. The method may further comprise setting the updated position of the first virtual camera further based on at least one previous position of the first virtual camera.

Generating the first transformed colour frame may be based on the position of the virtual camera and a known position of the first camera.

The first transformed colour frame may be generated such that a location of the first user in the first transformed colour frame matches a location of the first user in the first current colour frame. The method may further comprise setting a rotation of the first virtual camera so that the location of the first user in the first transformed colour frame matches the location of the first user in the first current colour frame. The rotation of the first virtual camera may be set based on the position of the first virtual camera and a depth of the first user from the first display.

Generating the first transformed frame may comprise panning and/or cropping the first current colour frame so that the location of the first user in the first transformed colour frame matches the location of the first user in the first current colour frame.

Setting the position of the first virtual camera may be further based on a location of the second user within at least one preceding frame of the second plurality of time-consecutive colour frames, wherein the at least one preceding frame precedes the second current colour frame in the second plurality of time-consecutive colour frames.

The method may further comprise: determining, based on the image content of the first current colour frame, whether at least one transformation adjustment condition is met; and if a transformation adjustment condition is met: adjusting the transformation applied to the first current colour frame in order to generate of the first transformed colour frame. The at least one transformation adjustment condition may comprise a pose condition, wherein determining whether the pose condition is met may comprise: determining a pose of the first user in the first current colour frame, wherein the pose comprises measures of pose in at least two dimensions; and if the magnitude of the determined pose is greater than the disablement threshold, the pose condition is met and the transformation is adjusted by disabling at least part of the transformation.

The method may further comprise comparing the determined pose to a reduction threshold that is smaller in magnitude than the disablement threshold, wherein if the magnitude of the determined pose is between the reduction threshold and the disablement threshold, the amount by which the first current colour frame is transformed to generate the first transformed colour frame is reduced compared with the transformation that would be applied if the magnitude of the determined pose were smaller than the reduction threshold.

The reduction threshold and the disablement threshold may define lower and upper limits of a range, and wherein the amount by which the transformation is reduced is dependent on where the magnitude of the determined pose is in the range. The amount by which the transformation is reduced may be proportional to where the magnitude of the determined pose is in the range.

The at least one transformation adjustment condition may comprise any one or more of: a proximity condition, wherein the proximity condition is met if a depth of the first user from the first camera is determined to be less than a proximity threshold; a distance condition, wherein the distance condition is met if a depth of the first user from the first camera is determined to be greater than a distance threshold.

The at least one transformation adjustment condition may comprise any one or more of: a compute resource condition, wherein the compute resource condition is met if a compute resource of a computing device on which at least part of the method is operating is determined to be less than a compute threshold; an object condition, wherein the object condition is met if object recognition performed on the first current colour frame identifies an object that is on a predetermined black list and/or if object recognition performed on the first current colour frame identifies an object that it cannot classify, wherein if the compute resource condition of the object condition are met, the transformation is adjusted by disabling the transformation and outputting the first current colour frame for display to the second user

The first current colour frame may comprise at least a first area and a second area, wherein the first area images a part of the first scene that is within a first depth range and the second area images a part of the first scene that is within a second depth range, and wherein generating the first transformed colour frame comprises separately transforming the first area and the second area, and wherein determining whether at least one transformation adjustment condition is met is based on the image content of the first current colour frame in the first area, and wherein adjusting the transformation comprises adjusting the transformation applied to the first area of the first current colour frame in order to generate the first transformed colour frame.

Adjusting the transformation applied to the first current colour frame may comprise: disabling the generation of the first transformed colour frame; and outputting the first current colour frame for display to the second user, rather than the first transformed colour frame.

The video communication between the first user and the second user may comprise data communication between a first electronic device associated with the first user and a second electronic device associated with the second user, wherein at least part of generating the first transformed colour frame is performed on the second electronic device.

Data communication from the first electronic device to the second electronic device may comprise the first video stream and data indicative of the location on the first display at which the second colour video is displayed relative to the position of the first real camera the first user.

Data communication from the first electronic device to the second electronic device may comprise a first current depth frame corresponding to the first current colour frame, wherein the first current depth frame is indicative of a depth at least part of the first scene from the first real camera.

The method may further comprise determining the first current depth frame using the first current colour frame and a third current depth frame captured by a third real camera that captures the first scene from a different position to that of the first real camera.

The video communication may be between the first user, the second user and a further user, the method further comprising: receiving a further video stream comprising a further colour video made up of a further plurality of time-consecutive colour frames capturing a further scene that includes the further user, wherein the further colour video is captured by a further real camera; the first user or the further user setting a position of a further virtual camera; generating a further transformed colour frame using the first current colour frame, wherein the further transformed colour frame appears to capture the first scene from the position of the further virtual camera; and outputting the further transformed colour frame for display to the further user.

The video communication between the first user, the second user and the third user may comprise data communication between a first electronic device associated with the first user, a second electronic device associated with the second user and a further electronic device associated with the third user, wherein data communication from the first electronic device to the second electronic device comprises: the first colour video, wherein at least part of generating the first transformed colour frame is performed on the second electronic device, and wherein data communication from the first electronic device to the further electronic device comprises: the first colour video, wherein at least part of generating the further transformed colour frame is performed on the further electronic device. The data communication from the first electronic device to the second electronic device may further comprise a first depth video comprising a first plurality of time-consecutive depth frames capturing the first scene. The data communication from the first electronic device to the third electronic device may further comprise the first depth video.

Setting the position of the first virtual camera and/or generating the first transformed current frame may be further based on a first current depth frame corresponding to the first current colour frame, wherein the first current depth frame is indicative of a depth at least part of the first scene from the first real camera. The method may further comprise generating the first current depth frame using the first current colour frame and a third current depth frame captured by a third real camera that captures the first scene from a different position to that of the first real camera.

In a fourth aspect of the present disclosure, there is provided a computer-readable medium comprising computer executable instructions stored thereon, which when executed by one or more processors, cause the one or more processors to perform the method according to any of the first, second and third aspects.

In a fifth aspect of the present disclosure, there is provided an electronic device configured to perform the method of any of the first, second and third aspects.

In a sixth aspect of the present disclosure, there is provided a system comprising: a first electronic device configured to perform the method according to any of the first, second or third aspects; and a second electronic device in data communication with the first electronic device over a network, wherein the first electronic device is configured to output the first transformed colour frame to the second electronic device over the network for display to the second user.

In a seventh aspect of the present disclosure, there is provided a system comprising: a first electronic device; and a second electronic device in data communication with the first electronic device over a network, wherein the second electronic device is configured to perform the method according to any of the first, second or third aspects and is configured to receive the first video stream from the first electronic device over the network.

### DRAWINGS

Aspects of the present disclosure are described, by way of example only, with reference to the following drawings, in which:

FIG. 1 shows an example video communication system;

FIG. 2 shows a video communication system with a video processor in accordance with an example of the present disclosure;

FIG. 3 shows a further video communication system with a video processor in accordance with an example of the present disclosure;

FIG. 4 shows a further video communication system with a video processor in accordance with an example of the present disclosure;

FIG. 5 shows a functional block diagram of a video processor according to an example of the present disclosure;

FIG. 6 shows example camera units in accordance with an aspect of the present disclosure;

FIG. 7 shows a functional block diagram of a video processor according to a further example of the present disclosure;

FIG. 8 shows an example of a real camera and a virtual camera in accordance with the present disclosure;

FIG. 9 shows a further example of a real camera and a virtual camera in accordance with the present disclosure;

FIG. 10 shows a further example of a real camera and a virtual camera in accordance with the present disclosure;

FIG. 11 shows an example positioning of a virtual camera in accordance with the present disclosure;

FIG. 12 shows a further example positioning of a virtual camera in accordance with the present disclosure;

FIG. 13 shows a functional block diagram of a transform determiner in according to an example of the present disclosure;

FIG. 14 shows a functional block diagram of a further transform determiner in according to an example of the present disclosure;

FIG. 15 shows a functional block diagram of a further transform determiner in according to an example of the present disclosure;

FIG. 16 shows a functional block diagram of a further transform determiner in according to an example of the present disclosure;

FIG. 17 shows an example video communication system in according to an example of the present disclosure;

FIG. 18 shows an example video communication system in according to an example of the present disclosure; and

FIG. 19 shows a computing system according to an example of the present disclosure.

### DETAILED DESCRIPTION

This disclosure relates particularly to the positioning of a virtual camera and the transformation of images/frames of a video stream captured by a real camera appear to have been captured from the position of the virtual camera. The real camera may be any type of video camera, for example a webcam on top of a computer monitor, or a webcam in the lid of a laptop computer, or a front facing camera on a mobile device. When used during a video call/conference, the real camera will capture images/frames of a scene that includes a person/user that is local to the real camera. A virtual camera can be positioned somewhere that is different to the position of the real camera-for example it may be positioned on the face (particularly at the eyes) of a displayed image of a remote person/user with whom the local person/user is having a video call/conference. The images/frames captured by the real camera then go through an image transformation process where they are modified so that they appear to capture the scene from the position of the virtual camera. During the video call/conference, the transformed video is displayed to the remote person/user, such that whenever the local person/user looks in the direction of where the virtual camera is positioned (for example, whenever they look at the image of the remote user), it will appear in the transformed video as though they are looking directly at the camera. As a result, the quality of interaction and communication may be significantly improved.

The position of the virtual camera may be set in many different ways. In some examples it is set automatically by the system, for example to track the location of the image of the remote user on the local user's display. In one instance of this, it may be positioned in the plane of the local user's display at a location that aligns with the image of the remote user, for example aligning with a feature of the remote user such as a point between their eyes. In another instance, it may be positioned behind the local user's display, at a point in 3D space that puts the virtual camera at a distance behind the local user's display that corresponds to the distance at which the remote user is from their display. The virtual camera may then automatically track any movements of the remote user relative to the image of the local user presented on the remote user's display. In this way, by moving (for example, left or right, up or down, towards or away from the remote user's display), they remote user may chance the perspective from which they view the local user and the scene in which they are located. Consequently, they may interact with the local user and scene in a way that more readily replicates a real-world interaction. In some other examples, the local user or the remote user may set the position of the virtual camera, for example manually fixing it to a particular location (for example, the local user setting a location corresponding to text that the local user is reading so that when they look at the text, the transformed video stream makes it appear is though they are looking directly at the camera, the remote user setting a location so that they can select the perspective from which they would like to see the remote user, or other objects in the first scene), or manually selecting something that the virtual camera should track (for example, manually selecting which remote user on a three person video call the virtual camera should track, such that whenever the selected remote user moves, or whenever the local user changes the position of the image of the remote user on the local user's display, the virtual camera moves with them).

Throughout this disclosure, the term ‘virtual camera’ is intended to mean the perspective from which the transformed video should appear to capture the scene. Therefore, setting a position of the virtual camera is intended to mean setting the position of the perspective from which the transformed video should appear to capture the scene. The virtual camera is not a physical object—instead, the position of the virtual camera may simply be any point in 3D space that can be described/defined mathematically. By knowing the position of the real camera (for example, as a result of user input or an earlier calibration process), the difference between the position of the real camera and the position of the desired perspective (eg, the position of the virtual camera), the required image transformation can be calculated so that the video captured by the real camera can be transformed so that it appears to capture the scene from the desired perspective. In some instances, two or more real cameras may be positioned to capture the same scene, but from different perspectives (for example, a camera unit that includes two cameras—such as a stereoscopic camera—or two or more independent cameras each capturing the same scene from different positions). In some examples the image transformation may be applied only to the colour video output by one of the cameras. In other examples, the at least two colour videos may be combined to create a combined colour video on which the image transformation is then applied. In any event, the required image transformation can be calculated using the known position of at least one of the real cameras relative to the position of the virtual camera.

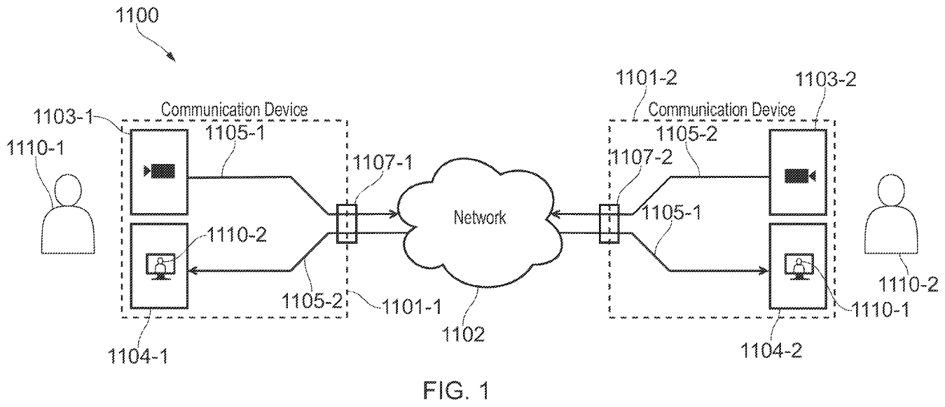

FIG. 1 shows a system 1100 which facilitates a video call between a first electronic device 1101-1 and a second electronic device 1101-2, via a network 1102. The first electronic device 1101-1 and the second electronic device 1101-2 each includes a respective video capture device or camera unit 1103-1 and 1103-2. Each video capture device/camera unit comprises at least one camera for capturing video footage. The first camera unit 1103-1 captures video footage of a first scene including a first user 1110-1 and outputs a first video stream 1105-1. The second camera unit 1103-2 captures video footage of a second scene including a second user 1110-2 and outputs a second video stream 1105-2. The first electronic device 1101-1 and the second electronic device 1101-2 each include a respective transceiver 1107-1 and 1107-2. The first video stream 1105-1 is transmitted to the network 1102 via the first transceiver 1107-1, and received by the second electronic device 1101-2 via the second transceiver 1107-2. Furthermore, the second video stream 1105-2 is transmitted to the network 1102 via the second transceiver 1107-2, and received by the first electronic device 1101-1 via the first transceiver 1107-1. The first electronic device 1101-1 and the second electronic device 1101-2 each includes a respective display 1104-1 and 1104-2. The first display 1104-1 receives the second video stream 1105-2 which is displayed by the display 1104-1. The second display 1104-2 receives the first video stream 1105-1 which is displayed on the display 1104-2.

The first video stream 1105-1 captured by the first camera unit 1103-1 will show a particular perspective or view of the first scene, based on the position of the camera unit 1103-1 within/relative to the scene. In particular, the images (i.e. frames) captured by the first camera unit 1103-1 will depend on the 3D translational and/or rotational position of the first camera unit 1103-1 within/relative to the scene. It is often the case that the first camera unit 1103-1 is positioned at some distance from the first display 1104-1. When the first user 1110-1 wants to engage directly with the second user 1110-2, the first user 1110-1 may look at the first display 1104-1 where they can see the second user 1110-2. In other words, the first user 1110-1 does not look directly at the first camera unit 1103-1. As such, from the perspective of the second user 1110-2 looking at the second display 1104-2, the first user 1110-1 will appear to be looking away from the second user 1110-2. It is impractical to position the physical camera unit 1103-1 over the display 1104-1 so that the first user 1110-1 appears to be looking directly at the camera unit 1103-1.

This disclosure typically describes in detail how a virtual camera may be implemented in relation to the first user 1110-1 and the first video stream 1105-1 transformed. Additionally or alternatively, a virtual camera may be implemented in relation to the second user 1110-2 and the second video stream 1105-2 transformed in exactly the same ways. When a virtual camera is implemented in relation to the first user 1110-1, a video processor may transform/alter first video stream 1105-1 so that when the first user 1110-1 is looking towards the position of the virtual camera, in the transformed first video stream the first user 1110-1 appears as though they are looking directly at the camera unit 1103-1. This may improve engagement and communication of visual cues between the first user 1110-1 and the second user 1110-2 during the video call.

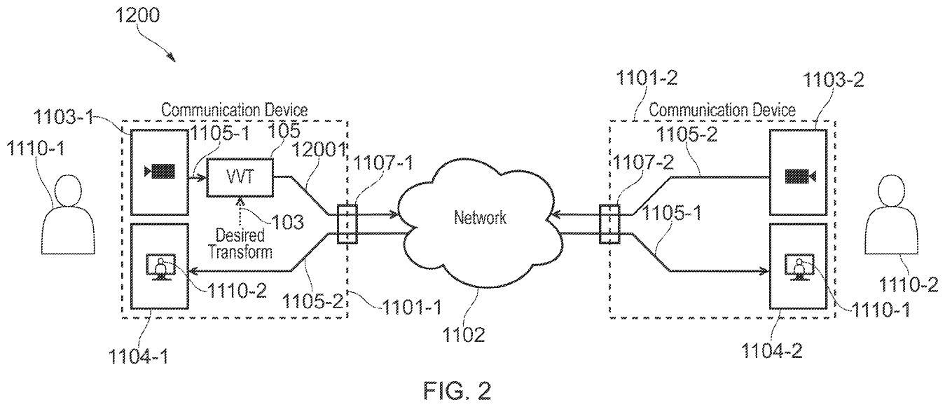

FIG. 2 shows a system 1200 according to an example of the present disclosure. The system 1200 corresponds to the system 1100 with the following differences.

As shown in FIG. 2, the first electronic device 1101-1 includes a video processor 105. The video processor 105 is in a transmit path of the first electronic device 1101-1 (i.e. between the camera unit 1103-1 and the transceiver 1107-1). The video processor 105 receives the first video stream 1105-1. The video processor 105 also receives transformation data 103. The transformation data 103 is indicative of a (3D) transformation between the actual position of the first camera unit 1103-1, and the position of the virtual camera (not shown) within the first scene. As such, the transformation data 103 indicates the desired change in view or perspective of the first video stream 1105-1. The transformation data 103 may be represented as a mathematical function. The transformation data 103 may include parameters indicative of the change in the 3D translational and/or rotational position between the camera unit 1103-1 and the virtual camera. In particular, the transformation data 103 may include translation parameters indicative of a change in a 3D translational position between the first camera unit 1103-1 and the virtual camera in 3D space. The transformation data 103 may also include rotation parameters indicative of a change in a 3D rotational position between the first camera unit 1103-1 and the virtual camera in 3D space.

The video processor 105 generates an output video stream 12001 based on the first video stream 1105-1 and the transformation data 103. In particular, for each individual frame (e.g. image) of the first video stream 1105-1, the video processor 105 applies a transformation to the image. The transformation transforms the image so that the image shows the scene from the perspective of the virtual camera instead of the first camera unit 1103-1. The transformed image may be considered as an estimation of the scene from the position of the virtual camera. The video processor 105 processes each image of the first video stream 1105-1 in real-time. The transformed images are outputted by the video processor 105 in real-time, to generate the output video stream 12001. Accordingly, the output video stream 12001 will appear to capture the scene from the perspective of the virtual camera instead of the first camera unit 1103-1. The output video stream 12001 is then transmitted to the second user device 1101-2 via the transceiver 1107-1 and the network 1102. As such, if the virtual camera is positioned where the image of the second user 1110-2 appears on the first display 1104-1, when the first user 1110-1 looks at the image of the second user 1110-2, their image on the second display 1104-2 will appear to the second user 1110-2 to be looking directly at them.

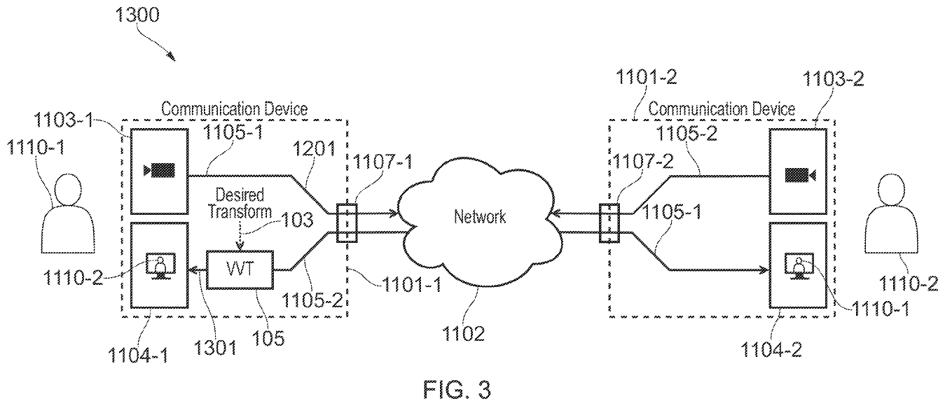

FIG. 3 shows a system 1300 according to another example of the present disclosure. The system 1300 is similar to the system 1200, except that the video processor 105 is in the receive path of the first electronic device 1101-1 (i.e. between the transceiver 1107-1 and the display 1104-1). In this example, the virtual camera is position in relation to the second user 1110-2 and the second video stream 1105-2 is transformed. The video processor 105 receives the second video stream 1105-2 and the transformation data 103. In the system 1300, the transformation data 103 is indicative of a transformation between the actual position of the second camera unit 1103-2, and the position of the virtual camera within the second scene. As such, the transformation data 103 indicates the desired change in view of the second video stream 1105-2. The video processor 105 generates an output video stream 1301 based on the second video stream 1105-2 and the transformation data 103. Accordingly, the output video stream 1301 will show the video footage from the perspective of the virtual camera instead of the second camera unit 1103-2. The output video stream 1301 is then displayed on the first display 1104-1. As such, if the virtual camera is positioned where the image of the first user 1110-1 appears on the second display 1104-2, when the second user 1110-2 looks at the image of the first user 1110-1, their image on the first display 1104-2 will appear to the first user 1110-1 to be looking directly at them.

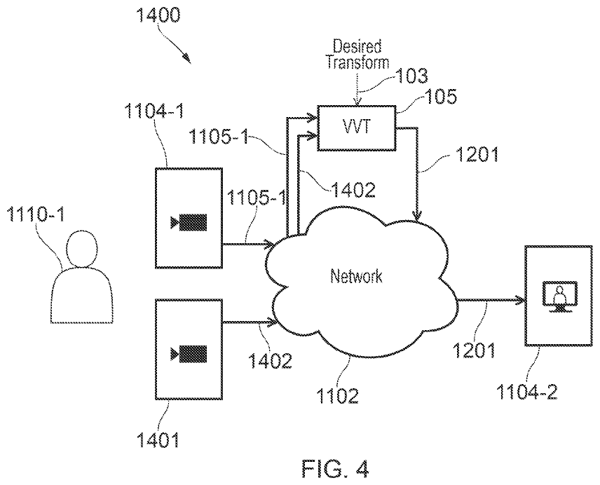

FIG. 4 shows a system 1400 according to another example of the present disclosure. The System 1400 is similar to the systems 1200 and 1300, except that the video processor 105 is not implemented in the first or second electronic devices. Rather, the video processor 105 may be implemented elsewhere in system 1400, for example elsewhere in the network 1102 (e.g. on a server, in the cloud, etc.). In this example, the virtual camera is position in relation to the first user 1110-1 and the video processor 105 may receive and process the first video stream 1105-1 to generate the output video stream 12001 (and/or is a virtual camera is positioned in relation to the second user 1110-2 it may receive and process the second video stream 1105-2 to generate the output video stream 1301).

The system 1400 may also include a third camera unit 1401. Like the first camera unit 1104-1, the third camera unit 1401 may also capture video footage of the first user 1110-1, but from a different position or angle to the first camera unit 1104-1. The third camera unit 1401 may output a third video stream 1402. The video processor 105 may generate the output video stream 12001 further based on the third video stream 1402. The third camera unit 1401 may be a physically separate device to the first camera unit 1104-1. The third camera unit 1401 may not be part of the first electronic device 1101-1, and may instead be independently connected to the network 1102. The third camera unit 1401 may belong to a different, third electronic device (not shown). As such, multiple independent camera units from different electronic devices can be used by the video processor 105 in order to generate the output video stream 12001.

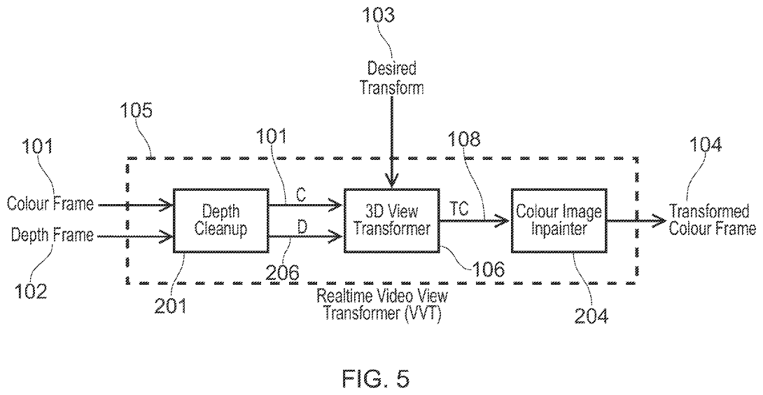

FIG. 5 shows an example implementation of the video processor 105 according to an example of the present disclosure. The video processor 105 receives an image comprising a colour frame 101 and/or a depth frame/data 102. The colour frame 101 may be part of an input video stream captured by a (real) camera (for example the video stream 1105-1). The video processor 105 also receives transformation data 103. The depth frame 102 may be considered as a depth image or depth map. The transformation data 103 may be considered as a transformation matrix. The video processor 105 is configured to generate an output a transformed image 104 (which may be part of the output video stream 12001) based on the input image (the colour frame 101 and/or the depth frame 102) and the transformation data 103. As explained earlier, the output image 104 shows the scene captured in the input image from the perspective of a virtual camera that is in a different position relative to the real camera. The output image 104 may be considered as an estimation of the scene from the perspective of the virtual camera.

The colour frame 101 has a size of a particular width of pixels x_{MAX} in the horizontal direction and a particular height of pixels y_{MAX} in the vertical direction. The colour frame 101 can therefore be considered as a 2D grid of pixels having a coordinate system [0, x_{MAX}], [0, y_{MAX}]. Individual pixels in the colour frame 101 can be uniquely identified by a pair of pixel coordinates (x, y). The x values are integers ranging from 0 to x_{MAX} in the horizontal direction (or along an x axis of the image) and the y values are integers ranging from 0 to y_{MAX} in the vertical direction (along a y axis of the image). Each pixel may be considered as a discrete location in the colour frame 101 that is capable of displaying a colour (e.g. based on RGB values, or a greyscale value, or any other suitable way of representing the visual appearance of the captured scene). As such, each pixel is also associated with a pixel value V(x, y). For example, each pixel value V may have a R (red) component, G (green) component and B (blue) component, which in combination determine the colour of the pixel. Alternatively, the pixel value V(x, y) may be a greyscale value which indicates the colour (in this case the grey level) of the pixel. The pixel coordinate (x, y) corresponds to the discrete location of the image grid in which the associated pixel value V(x, y) (i.e. colour) should be generated and displayed. Each pixel may be considered as having a pixel size made up of a pixel width in the x direction and a pixel height in the y direction. For simplicity, the pixel width and height may be considered as being one integer, such that each pixel occupies a 1×1 area of the 2D image grid.

The depth frame 102 includes a depth value d(x, y) for each pixel (x, y) of the image 101. The depth value d(x, y) indicates the depth of the respective pixel (x, y) of the image 101, e.g. from the perspective or view of the real camera. The depth value d(x, y) may be considered as a distance from the real camera of the thing (i.e., the object surface) that is imaged by the pixel (x, y). Similarly to the colour frame 101, the depth frame 102 will have a size of a particular width of pixels x_{MAX} in the horizontal direction and a particular height of pixels y_{MAX} in the vertical direction. The depth frame 102 can therefore be considered as a 2D grid of pixels having a coordinate system [0, x_{MAX}], [0, y_{MAX}]. Individual pixels in the depth frame 102 can be uniquely identified by a pair of pixel coordinates (x, y). The x values are integers ranging from 0 to x_{MAX} in the horizontal direction (or along an x axis of the image) and the y values are integers ranging from 0 to y_{MAX} in the vertical direction (along a y axis of the image). Each depth pixel may be considered as a discrete location in the depth frame 102 that is associated with a depth value d(x, y). The depth frame 102 may be visually displayed as a greyscale image. Similarly to the colour frame 101, the pixel coordinate (x, y) corresponds to the discrete location of the image grid in which the associated pixel value d(x, y) (i.e. depth) should be generated and displayed. Each pixel may be considered as having a pixel size made up of a pixel width in the x direction and a pixel height in the y direction. For simplicity, the pixel width and height may be considered as being one integer, such that each pixel occupies a 1×1 area of the 2D image grid.

The transformation data 103 is indicative of a 3D transformation between the position of the real camera and the position of the virtual camera relative to the scene. As such, the transformation data 103 indicates the desired change in view of the input video stream. The transformation data 103 may be represented as a mathematical function. The transformation data 103 may correspond to a 3D transformation matrix. The transformation data 103 may include parameters indicative of the change in the 3D translational and/or 3D rotational position between the real camera and the virtual camera. In particular, the transformation data 103 may include translation parameters indicative of a change in a 3D translational position between the real camera and the virtual camera in 3D space. The transformation data 103 may also include rotation parameters indicative of a change in a 3D rotational position between the real camera and the virtual camera in 3D space.

The video processor 105 is configured to generate an output image 104 based on the input colour frame 101 and depth frame 102, and the transformation matrix 103. The output colour frame 104 will show the scene captured in the input image, but from the perspective of the virtual camera instead of the perspective of the real camera. The output colour frame 104 estimates the scene from the perspective of the virtual camera. For simplicity, the output image 104 may be considered as having the same size as the image 101, and therefore the same number of pixels.

The video processor 105 may include an image transformation module/unit 106 (i.e. an image transformer, also referred to as a 3D view transformer) which receives the colour frame 101, depth frame 102, and the transformation matrix 103. The image transformer 106 processes the colour frame 101 based on the depth frame 102 and the transformation matrix 103 to generate a transformed image 108. The image transformer 106 may also use camera parameters of the real camera to generate the transformed image 108, such as the focal length and/or the centre point of the real camera. The transformed image 108 shows the scene captured in the colour frame 101, but from the perspective of the virtual camera. The transformed image 108 may have the same size and dimensions as the colour frame 101. The transformation module/unit 106 is not the subject of the present disclosure, and the skilled person will be aware of how to transform a frame so that it appears to capture a scene from a different perspective. However, by way of brief explanation, the transformation module/unit 106 transforms the input image by transforming each pixel value in position x, y of the input image to a position x′, y′ so that the same parts of the scene appear in the transformed image to be captured from a different perspective. The transformation of position x, y to x′, y′ can be determined using the transformation matrix 103, where pixel position x, y is first converted to a theoretical 3D point in space based on the real camera characteristics (eg, focal length and/or centre point) and is then transformed to the coordinate system of the virtual camera using the transformation matrix that described the relationship between the real camera and the virtual camera, before being projected to a new x′, y′ position in the transformed image. Once the relationship between x, y and x′, y′ is determined, the corresponding R, G and B colour of pixel x, y, from the original image can be mapped to location x′, y′ in the transformed image.

Due to the change in position between the real camera and the virtual camera, the transformed image 108 may include gaps or holes, i.e. regions of undefined pixels, or pixels without assigned values. Said pixels may be considered as a type of erroneous pixel, in particular missing pixels. The missing pixels may correspond to parts of the scene that the real camera was originally unable to see. As such, the video processor 105 may optionally further include an inpainter 107, which may also be considered as a filler 107. The inpainter 107 is configured to inpaint the transformed image 108. The inpainter 107 receives the transformed image 108 and corrects the erroneous pixels. In particular, the inpainter 107 may assign values (i.e. colour) to the missing pixels. The operation of the colour inpainter 107 is not the focus of the present disclosure, so its detailed operation shall not be described any further.

In some scenarios, the depth frame 102 may not be accurate (e.g. it may have incorrect depth values at some pixel locations). A depth corrector 201 may optionally be included in the video processor 105 and configured to identify incorrect depth values in the depth frame 102 and optionally correct at least some of the identified incorrect depth values. The depth corrector 201 receives the depth frame 102 and the colour frame 101 and outputs the colour frame 101 and a modified depth frame 206. The modified depth frame 206 corresponds to the depth image 102 but with the identified inaccurate/incorrect pixels either marked (for example, deleted so that the pixel has no value) or corrected (for example, the inaccurate/incorrect depth value replaced with a more accurate/correct depth value). As such, the depth corrector 201 may reduce inaccuracies in the depth frame 102. The operation of the depth corrector 201 is not the focus of the present disclosure, so its detailed operation shall not be described any further.

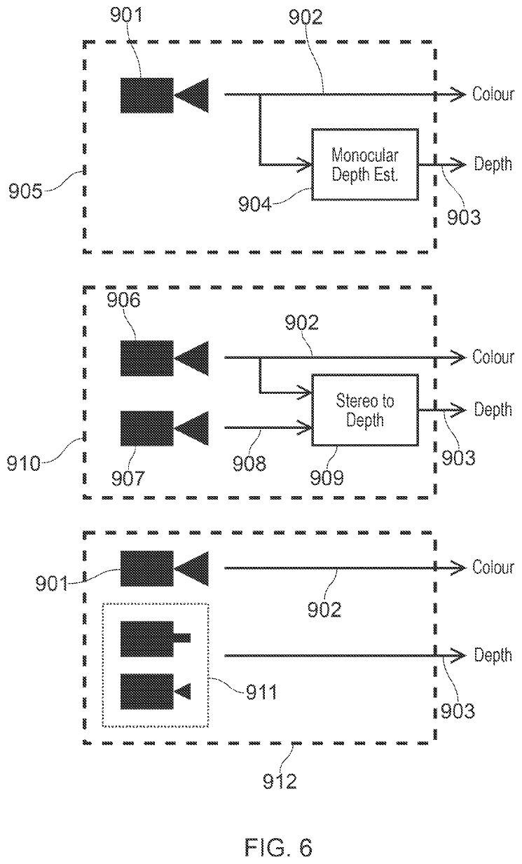

FIG. 6 shows examples of camera units or video capture devices which may be used to capture video streams in accordance with present disclosure. Moreover, shows camera units that are capable of generating the depth data 102. The camera units 1103-1 and 1103-2 described previously may correspond to any of the camera units shown in FIGS. 2 to 4.

One example camera unit 905 includes a single camera 901. The camera 901 may be any suitable camera, such as a USB camera, webcam, etc. The camera 901 generates a video stream 902 comprising images spaced at a frame rate. The camera unit 905 also includes a depth estimator 904. For each image outputted by the camera 901, the depth estimator 904 estimates the depth of each pixel in the image. Any monocular depth estimation technique may be used. For example, the depth estimator 904 may have knowledge of the scene, and/or use machine learning. The depth estimator 904 outputs a stream of depth frames 903.

Another example camera unit 910 includes a stereo pair of cameras 906 and 907. The cameras 906 and 907 are spaced relatively close to one another to capture the same scene (e.g. a few centimetres apart). The camera 906 outputs the video stream 902 and the camera 907 outputs the video stream 908. The camera unit 910 includes a stereo depth estimator 909. For each image in the video stream 902, the stereo depth estimator 909 compares the image to the corresponding image from the video stream 908 to determine the depth of each pixel in the image. Any suitable stereo depth estimation technique, such as feature matching or block matching, may be used. The stereo depth estimator 909 then outputs a stream of depth frames 903.

Another example camera unit 912 includes the camera 901 and a time of flight unit 911. The camera 901 outputs the video stream 902, and the time of flight unit 911 independently determines the depth of each pixel in each image of the video stream 902.

It will be appreciated that each of the camera units 905, 910, 912 only generate one channel of data. In particular, each camera unit only outputs one video stream and one depth data stream.

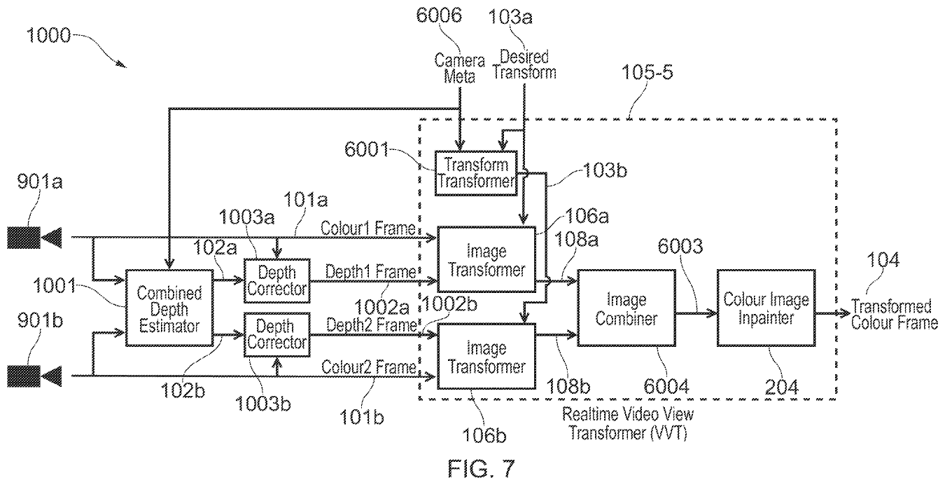

FIG. 7 shows a system 1000 according to an example of the present disclosure. The system 1000 includes a video processor 105-5 according to an example of the present disclosure. The video processor 105-5 is configured to combine images from two video streams in order to form the final output image 104.

The video processor 105-5 includes a first channel “a” and a second channel “b”. The first channel receives a colour frame 101a of a first input video stream captured by a first real camera (i.e. camera 901a), and a corresponding depth frame 1002a. Furthermore, the second channel receives a colour frame 101b of a second input video stream, and a corresponding depth frame 1002b. The second video input stream is captured by a second real camera (i.e. camera 901b). The second real camera is positioned to capture the same scene or environment as the first real camera, but at a different position or angle to the first real camera. For example, if the scene includes a human subject in a video call setting, the first real camera 901a may be positioned to capture more of the left side of the human's face and the second real camera 901b may be positioned to capture more of the right side of the human's face. As such, the colour frames 101b of the second input stream are related to the frames 101a of the first input stream, in the sense that they show the same scene but from a different angle or perspective. Moreover, it will be appreciated that the first and the second real cameras may capture images at the same frame rates, and approximately at the same points in time.

Each of the first channel and the second channel include an image transformation module/unit 106a and 106b, respectively. The image transformation modules 106a and 106b function similarly to the image transformation module 106 described previously.

The image transformation module 106a may receive first transformation data 103a, which is indicative of a transformation between the position of the first real camera and the position of the virtual camera relative to the scene. The first transformation data 103a may be characterised and function similarly to the transformation data 103 described previously. Consequently, the image transformation module/unit 106a generates a first transformed image 108a which shows the scene captured in the colour frame 101a from the perspective of the virtual camera.

The image transformation module 106b may not use the first transformation data 103a used in the first channel, because the colour frame 101b is captured using the second real camera that is in a different position to the first real camera. As such, the video processor 105-5 may include a transform adjustment block 6001. The transform adjustment block 6001 receives the first transformation data 103a. The transform adjustment block 6001 processes or transforms the first transformation data 103a to generate second transformation data 103b. The second transformation data 103b is indicative of a transformation between the position of the second real camera 901b and the position of the same virtual camera relative to the scene. As such, the second transformation data 103b can be used by the second channel. The second transformation data 103b can be generated using camera metadata 6006 which is received by the transform adjustment block 6001. The camera metadata 6006 is indicative of the relative position between the first and second real cameras. The transform adjustment block 6001 may transform the transformation data 103a based on the camera metadata 6006 to generate the second transformation data 103b. Consequently, the image transformation module 106b may be able to generate a second transformed image 108b, which shows the scene captured in the image 101b from the perspective of the same virtual camera. The first transformed image 108a and the second transformed image 108b are different estimates of the scene from the perspective of the virtual camera. The image transformation module 106b may use camera parameters of the second real camera to transform the pixel coordinate, such as the focal length and/or the centre point of the second real camera.

Since the first real camera 901a and the second real camera 901b capture the same scene from different angles, some areas of the scene may be better visible to the second real camera 901b or the first real camera 901a. As such, the first transformed image 108a and the second transformed image 108b may be combined by an image combiner 6004 to generate a more complete and higher quality combined image 6003.

It will be appreciated that although only two channels are shown in FIG. 2, more than two channels are also envisaged. For example, additional channels may receive additional video streams from additional cameras and process the video streams in a similar way to the first and the second channels described above, and the image combiner 6004 may generate the image 6003 further based on the additional transformed pixel data generated by the additional channels (e.g. by selecting the pixel with the highest quality score, or blending the pixels proportionally to the quality score).

The first and second real cameras 901a and 901b may be set up as follows. For example, with a subject sitting in front of and using a typical 24-28 inch display unit (e.g. monitor), it may be desired to position the virtual camera anywhere across a 40 cm distance in the x direction. As such, the real cameras can be set up on either side of the 40 cm space to capture the scene from different angles. As a result, the real cameras will capture sufficient image content to generate the final output image 104, whilst putting less burden on the inpainter 204.

It will be appreciated that the cameras can be arranged independently of one another and belong to different electronic devices (e.g., different webcam units or video conferencing cameras). For example, the cameras can be positioned in a meeting room to capture attendees from different angles.

It will be appreciated that the positioning of the first and second real cameras 901a and 901b may differ from a pair of stereo cameras. Stereo cameras may be placed intentionally close to one another, to capture the scene from almost the same angle in order to determine the depth of the scene. However, the first and second real cameras may be placed at a greater distance apart, in order to capture the same scene from different angles and/or positions, so that each camera may intentionally capture different views of the scene.

The operation of the video processor 105-5 is not the focus of the present disclosure, so its detailed operation shall not be described any further.

FIG. 7 further shows how the colour frame outputs of the first and the second cameras 901a and 901b may be used to determine the corresponding depth frames 102a and 102b for each channel. As described previously, the cameras 901a and 901b may be spaced at a sufficient distance apart (e.g. at the extremities of the region in the scene where the virtual camera is likely to be placed), in order to capture more pixel data of the scene. As a result, although the cameras 901a and 901b capture the same scene from different angles, the images captured by the cameras 901a an 901b will not contain the same parts of the scene. Rather, there may be significant parts of the colour frame 101a that are not present in the colour frame 101b. As such, stereo depth estimation techniques may not be suitable to determine the complete depth frames from the outputs of the cameras 901a and 901b.

The system 1000 may therefore include a depth estimator 1001 which receives each of the colour frames 101a and 101b. The depth estimator 1001 may also receive the camera metadata 6006, which indicates the relative positions of the cameras 901a and 901b as described above. The depth estimator 1001 may generate depth frame 102a and depth frame 102b based on the colour frames 101a and 101b, and the camera metadata 6006.

Using the camera metadata 6006, the depth estimator 1001 may identify pairs of pixels of the colour frames 101a and 101b that correspond to the same location in the scene. In particular, for each pixel of the colour frame 101a, the depth estimator 1001 may determine whether there is a corresponding pixel in the colour frame 101b that captures the same location within the scene. The corresponding pixel may have a different coordinate to the pixel of the colour frame 101a. The depth estimator 1001 may make this determination based on the camera metadata 6006. If a corresponding pair of pixels is found, then the depth estimator 1001 may determine the depth of the pixel in the colour frame 101a based on the difference between the coordinate of the pixel in the colour frame 101a and the coordinate of the corresponding pixel in the colour frame 101b. Furthermore, the depth of the corresponding pixel in the colour frame 101b may also be determined in similar way. The depth estimator 1001 may output the depth frame 102a which includes the depths of the pixels of the colour frame 101a for which a corresponding pixel was found. Furthermore, the depth estimator 1001 may output the depth frame 102b which includes the depths of the corresponding pixels of the colour frame 101b.

It will be appreciated that each of the depth frames 102a and 102b may include some errors or inaccuracies, since the combined depth estimator 1001 is unlikely to estimate depths perfectly based on the colour frames 101a and 101b. Therefore, a depth corrector 1003a may be used to identify incorrect/inaccurate depth pixels in the depth frame 102a and output a modified depth frame 1002a, which is then used by the two-channel video processor 105-5. Likewise, a depth corrector 1003b may be used to identify incorrect/inaccurate depth pixels in the depth frame 102b and output a modified depth frame 1002b, which is then used by the two-channel video processor 105-5. Each of the depth correctors 1003a and 1003b may be implemented and operate in the same way as the depth corrector 201 described with reference to FIG. 1. However, the operation of the depth corrector(s) is not the focus of this disclosure and, as such, shall not be described in any further detail.

Advantageously, the system 1000 does not require any dedicated hardware (e.g. stereo camera pairs or time of flight units) in order to determine the depths of each pixel in the colour frames 101a and 101b. Rather, the two-camera setup 901a and 901b can be used to determine the depth values, whilst achieving the advantages of the two-channel video processor 105-5.

Optionally, the video processor 105-5 may be modified to only use the colour frames and depth frames from one source camera, for example 101a and 1002a, and either ignore, or not receive, the colour frame and depth frame from the other source camera, for example 101b and 1002b. In such arrangement, the depth estimation 1001 may use the colour frames 101a and 101b from both cameras 901a and 901b as shown in FIG. 2. Optionally, depth correction may be conducted on only one depth frame, for example 102a, and the other depth corrector 1003b may be omitted. In this case, the view transformer 105-5 may be configured in the same way as any of the view transformer shown in FIG. 1.

Whilst in this example the depth frames 102a, 102b are generated by a combined depth estimator 1001, in an alternative the depth frames may be generated by any of the camera units described above with reference to FIG. 6. In this case the combined depth estimator 1001 may be omitted and each of the cameras 901a, 901b may be configured in any of the ways represented in FIG. 6, and may output their depth frames 102a, 102b to the respective depth correctors 1003a, 1003b.

The main focuses of the present disclosure are: techniques for setting the position of the virtual camera; techniques for altering the transformation applied to the video stream in order to generate the transformed video stream that captures the scene from the perspective of the virtual camera; system/architecture implementations that may improve process efficiency and speed, and reduce latency. Each of these shall be described in turn.

### Setting the Position of the Virtual Camera

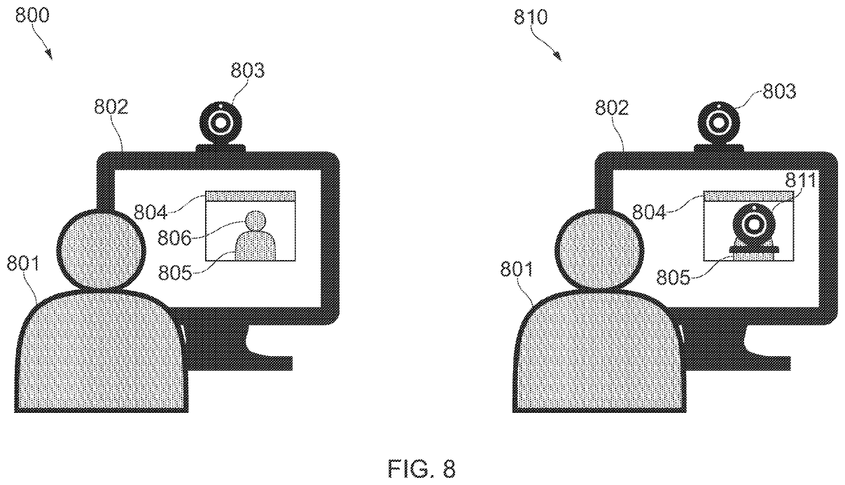

FIG. 8 shows a visualisation of positioning a virtual camera at the location of an image of the remote user displayed on the display of the local user. The term ‘local’ user is used throughout this disclosure to describe the person/user who is in the scene that is captured in the transformed video stream from the perspective of the virtual camera. The term ‘remote’ user is used throughout this disclosure to describe the person/user who is participating in a video communication with the local user and who views the transformed video stream on their display. In an alternative, the local user may be referred to as a ‘first user’ (for example, the first user 1110-1 in any of FIGS. 2 to 4) and the remote user may be referred to as a ‘second user’ (for example, the second user 1110-2 in any of FIGS. 2 to 4). Likewise, the terms ‘local real camera’ and ‘local display’ may be referred to as ‘first real camera’ and ‘first display’, and the terms ‘remote real camera’ and ‘remote display’ may be referred to as ‘second real camera’ and ‘second display’.

The lefthand side 800 of FIG. 8 shows an example first user 801 who is positioned in front of their first display 802. A first real camera 803 captures colour images of the scene (the ‘first’ scene) in which the first user 801 is located and outputs a first colour video stream (eg, a first plurality of time-consecutive colour frames). The term ‘real’ camera is used throughout this disclosure to describe a physical camera that is capturing colour images/frames of a scene, in contrast to a ‘virtual’ camera that is essentially just a perspective or point in space from which there is a desire to view the scene. The first user 801 is conducting video communication with a second user 805 and a second colour video stream (eg, a second plurality of time-consecutive colour frames) of a second scene that includes the second user 805 is displayed on the first display 802 in an application window 804. The second user's head is identified with reference numeral 806. The second user 805 will similarly be positioned in front of their display (a ‘second’ display) in a different location, with a second camera capturing the scene in which they are located and a colour video stream of the first user 801 displayed on their second display.

The righthand side 810 of FIG. 8 shows a visualisation of a virtual camera 811 positioned at the location corresponding to the image of the second user 805 on the first display 802. In this example, the virtual camera 811 is located to align with the head 806 in the image of the second user 805 displayed on the first display 802 (for example, where a feature, such as the eyes, of the second user 805 is displayed on the first display 802). As explained earlier, the virtual camera 811 is simply a perspective from which a transformed version of the first colour video stream should capture the first scene in which the first user 801 is located. As such, in practice a visualisation of the virtual camera 811 is unlikely to appear on the first display 802 as it would interfere with the video communication experience of the first user 801. However, a visualisation of the virtual camera 811 is included in FIG. 8 to assist in understanding the invention.

In this example, the position of the virtual camera 811 is automatically set based on: a location on the first display 802 at which the second colour video stream (i.e., the video capturing the second scene in which the second user 805 is located) is displayed (i.e., the location of the application window 804 on the first display 802) and the location of the second user 805 within the current frame of the second colour video stream. Based on this information, the location of the image of the second user 805 on the first display 802 can be determined and the position of the virtual camera 811 set based on that (for example, set to be at the same location as the image of the second user 805 on the first display 802, or more particularly to be the same location as a part or feature of the second user 805, such as the mid-point between their eyes, or their nose, etc). The location on the first display 802 at which the second colour video stream is displayed can be determined in any standard way known to the skilled person, for example using existing user interface (UI) managers or by known image detection processes on the data displayed by the first display 802. Likewise, the position of the second user 805 within the current frame of the second colour video stream may be determined in any standard way known to the skilled person, for example by performing image recognition on the current frame of the second colour video stream in order to identify the second user 805. This may include, for example, using an object recognition program/algorithm configured to identify one or more human features, such as eyes, nose, mouth, ears. The skilled person will be aware that there are various different software programs/algorithms that may be used for this, some of which may make use of a trained neural network/AI. For example, the face of the user may be detected using high-speed object detection algorithms of neural networks, such as ‘You Only Look Once’, YOLO, or other similar detectors. Features such as the user's eyes may then, for example, be detected using haar-like wavelet feature detection filters, or using high-speed classification network such as MobileNet, etc In this example, the position of the virtual camera 811 is effectively set to be on the surface of the first display 802 (i.e., on the same plane as the surface of the first display 802).

In this example, there is only one real camera 803 capturing the scene in which the first user 801 is located. This camera arrangement is therefore the same as represented in any of FIGS. 2 and 3.

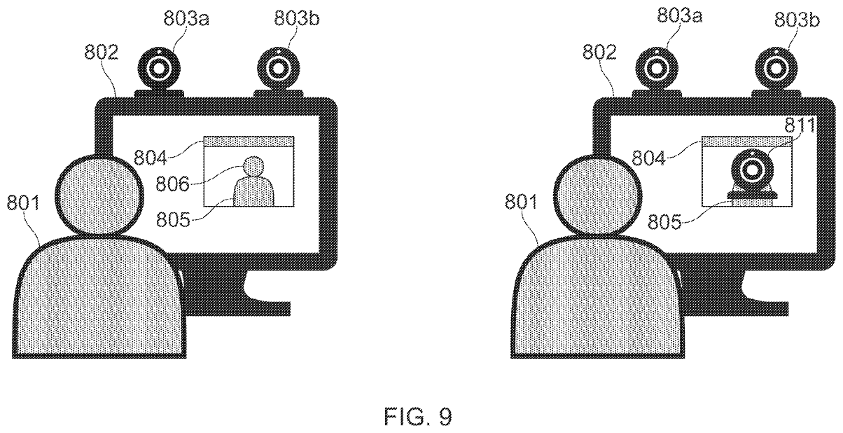

FIG. 9 shows a very similar example to FIG. 8, except that there are two independent real cameras capturing the first scene in which the first user 801 is located. This camera arrangement may therefore be the same as represented in FIGS. 4, 910 in FIG. 6, and FIG. 7.

In the example of FIG. 9, there is a first real camera 803a and a further real camera 803b, both capturing colour frames/images of the first scene, but from different perspectives. The colour video streams they each output may be used in any of the ways described above with reference to FIGS. 4, 6 and 7.

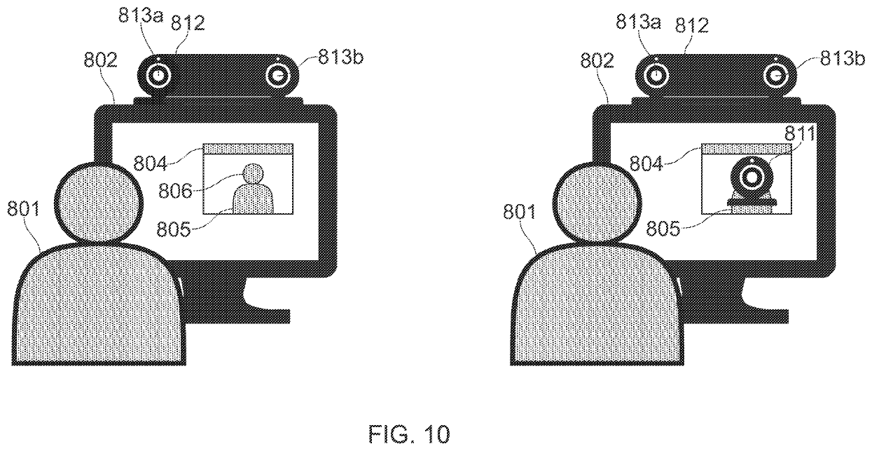

FIG. 10 shows a very similar example to FIG. 9, except that a camera unit 812 having two cameras is used, which includes a first real camera 813a and a further real camera 813b. Again, the colour video streams that each of the real cameras generate may be used in any of the ways described above with reference to FIGS. 4, 6 and 7. In this example, in contrast to the arrangement of FIG. 9, the position of the two real cameras relative to each other is always fixed and known.

Once the position of the virtual camera 811 has been set, the required transformation of the first colour video stream output by the first camera 803, 803a, 813a may be determined. The required transformation may be determined based on the known position of the first camera 803, 803a, 813a and the position of the virtual camera 811. The position of the first camera 803, 803a, 813a may be known as a result of earlier user input and/or calibration. For example, the first user may have earlier input to the system details of where the first camera 803, 803a, 813a is positioned relative to the first display 802 (for example, x, y and z distances from a point on the first display 802, for example from one of the corners of the first display 802 or from a centre point of the first display 802. The distances may be input in any suitable units, such as millimetres, centimetres, etc and may describe the horizontal distance—x distance—from the point of the first display 802 to the first real camera, the vertical distance—y distance—from the point of the first display 802 to the first real camera, and the depth distance—z distance—from the point of the first display 802 to the first real camera. Alternatively, it may be assumed that the first camera is located in the same plane as the surface of the first monitor 802, in which case only x and y dimensions may be input). In an alternative, the position of the real first camera 803, 803a, 813a may be detected by performing an earlier calibration process. The position of the real first camera 803, 803a, 813a may then be stored in memory within the system.

As explained earlier, the required transformation may be described by the transformation data 103, which may be indicative of the 3D transformation between the position of the first real camera 803, 803a, 813a and the virtual camera 811. It may be represented as a mathematical function, for example as a 3D transformation matrix that include parameters indicative of the change in the 3D translational and/or 3D rotational position between the first real camera 803, 803a, 813a and the virtual camera 811. The skilled person will readily understand how to generate such transformation data 103 if given a position of the first real camera and the position of the virtual camera 811.

The current frame of the first colour video stream may then be transformed using the transformation data 103 to generate a first transformed colour frame, which appears to capture the first scene from the perspective of the virtual camera 811. This transformation may be executed in any suitable way, for example as described above with reference to FIGS. 2 to 7. The first transformed colour frame is then output for display to the second user on their display.

This process of automatically setting the position of the virtual camera 811 and then transforming the current frame of the first colour video stream may be repeated for each new frame of the first colour video stream. As a result, the video stream displayed on the second user's display will appear to capture the first scene (and therefore the first user 801) from the perspective of the virtual camera 811.

By automatically setting the position of the virtual camera 811 in the way described above, whenever the first user 801 looks at the image of the second user 806 on the first display 802, it will appear on the second user's display as if the first user 801 is looking directly at the second user. Therefore, a more natural interaction with eye-contact may be achieved. Furthermore, if the second user 806 moves relative to the second camera that is capturing the images of them and/or if the first user 801 changes the location of the application window 804, the position of the virtual camera 811 will automatically track the location of the image of the second user 805 on the first display 802. Consequently, the effect of achieving natural eye contact can be maintained.

Optionally, a rotation may also be applied to the virtual camera 811, to rotate it around the x and/or y axis. This should have the effect of shifting (or panning) the video that is displayed on the second user's display, and may also cause some perspective change in the scene captured by the virtual camera 811.

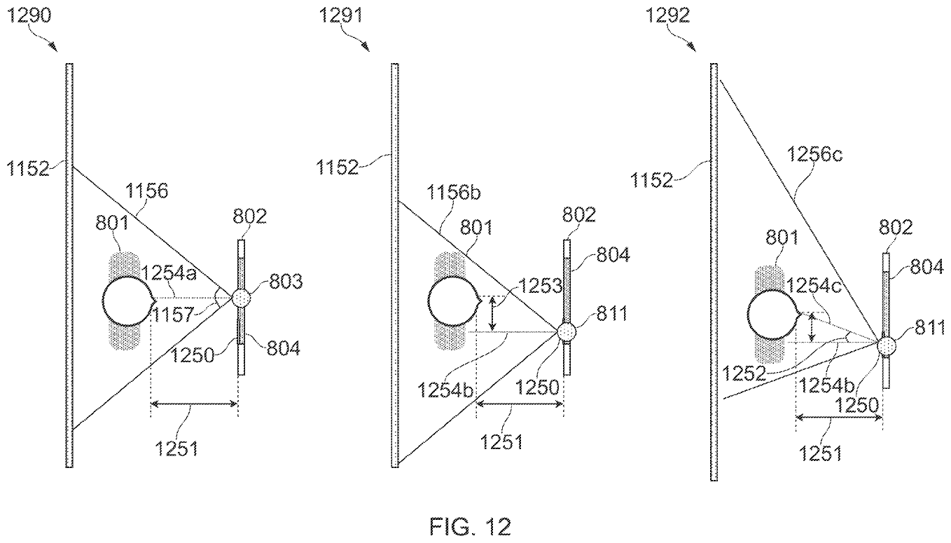

Rotating the virtual camera 811 in this way should cause a change in the position of the face of the first user 801 that is being rendered in the video displayed on the second user's display. In some scenarios this may be desirable and the amount of rotation applied may be determined based on the position of the first user 801 within the captured video, for example to keep the image of the first user 801 in the same position within the video that is displayed on the second user's display. In other scenarios, the amount of rotation applied may be set in order to keep the visual direction of the virtual camera 811 in the same location. Further details of virtual camera rotation are given in relation to FIG. 12 below. In an alternative, rather than setting the virtual camera to be at a position on the surface of the first display, it may be set at a point in 3D space that is behind the first display (from the perspective of the first user, who would be in front of the display viewing the images presented on the display). In this alternative, the transformed video frames may better replicate a viewing experience for the second user as if they are sat directly behind the first display, looking at the first user through a hole in the display that is the size of the video application window that is on the first display (eg, the window 804 in FIGS. 8 to 10).

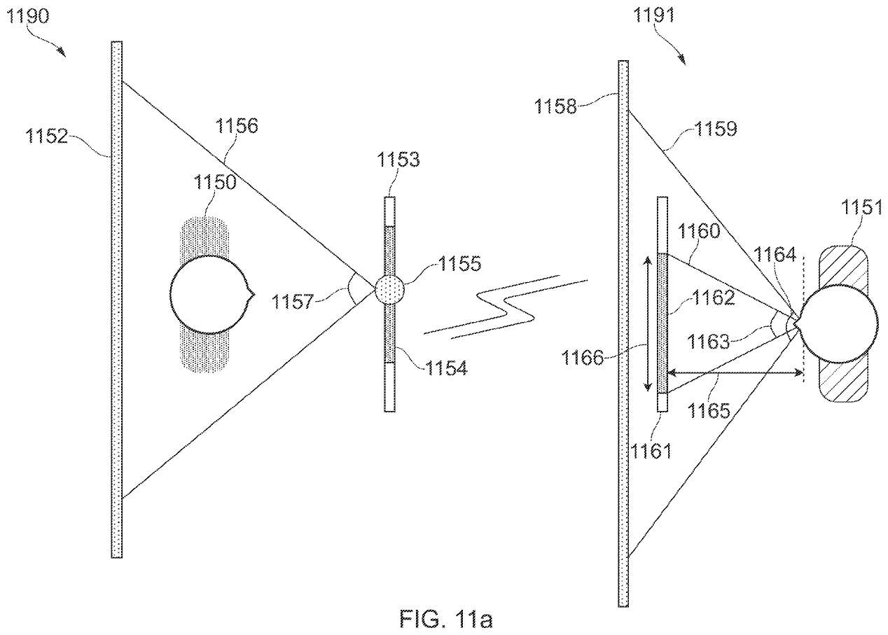

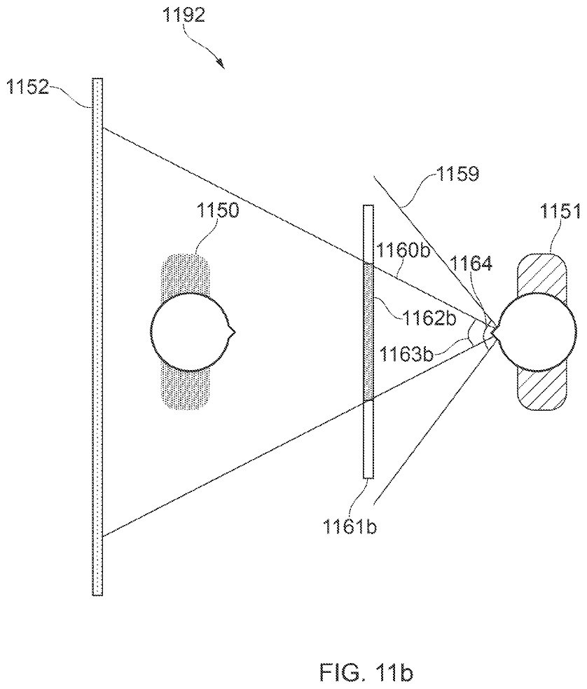

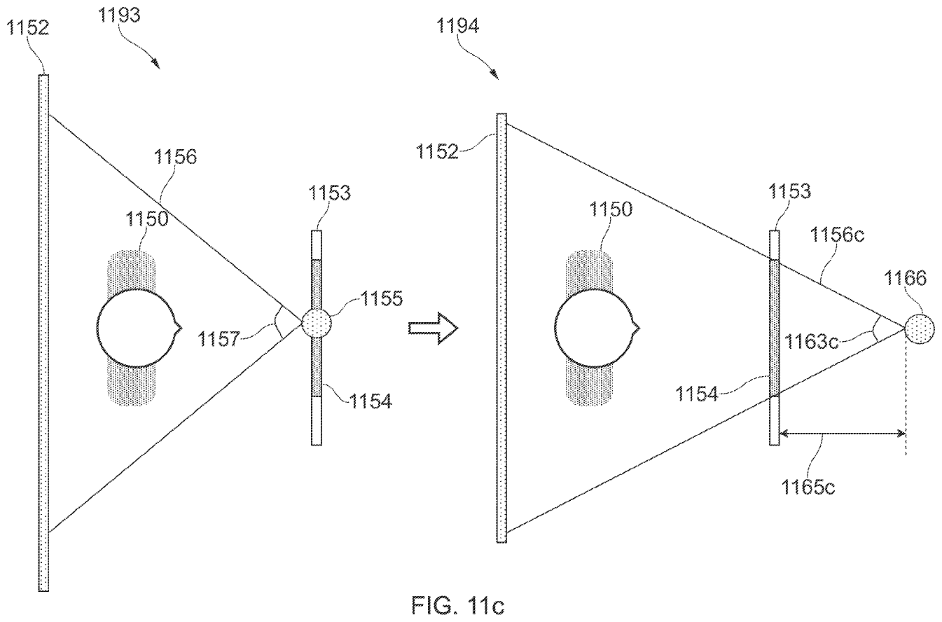

FIGS. 11a-11c show representations to help explain this concept. FIG. 11a shows a top-down perspective view of a first user 1150 in front of a first display 1153 and first real video camera 1155. This arrangement is the same as that represented on the lefthand side of FIG. 8. The first real video camera 1155 has a viewing angle 1157 and a field of view 1156 that captures a first scene that includes the first user 1150 and a wall 1152 that is behind them. The location on the first display 1153 at which a video of the second user 1151 is displayed (eg, the application window 804 in FIG. 8) is represented by 1154.

The second user 1151 is at a different location (for example, in a different country, or different region, or different building, or different room) to the first user 1151. They, similarly to the first user 1150, are positioned in front of a second display 1161, on which they are viewing a video stream 1162 of the first user 1150. The video stream 1162 is a transformed video stream comprising transformed colour frames that capture from the perspective of the virtual camera the first scene in which the first user 1150 is located. A second real camera (not represented in FIG. 11a for the sake of clarity) captures the second scene in which the second user 1151 is located, and the second colour video stream generated by the second real camera may be viewed on the first display 1153 at the location represented by 1154. The vision of the second user 1151 will have a viewing angle 1164 (typically around 135 degrees in the horizontal direction) and a field of view 1159. Some of the second user's vision includes the displayed image 1162 of the first user, which is represented by angle 1163 and view 1160.

FIG. 11b shows a visualisation of the effect that we would like to create using the virtual camera. The effect attempts to recreate what the second user 1151 would experience if they are in close physical proximity to the first user 1150, and looking at them through a hole or window 1162b in a wall 1161b. The hole or window 1162b corresponds to the application window 1162 in which the video of the first user 1150 is presented on the second display 1162. The second user's vision through the hole or window 1162b is represented by angle 1163b and view 1160b. The view 1160b includes the first user 1150 and part of the wall 1152 behind them. As will be appreciated, if the second user 1151 changes position, their view of the first scene that includes the first user 1150 will change. For example, if they move towards the hole or window 1162b, the angle 1163b and view 1162b will widen and they will see more of the wall 1152. If they move further back from the hole or window 1162b, the angle 1163b and view 1162b will decrease and they will see less of the wall 1152. If they move to the left, they will see more of one side of the first user 1150 than the other.

FIG. 11c shows a visualisation of how the effect is achieved by setting the virtual camera at a position in 3D space that is behind the first monitor 1153. The lefthand side 1193 of FIG. 11c shows the arrangement of the first display 1153 and first real camera 1153, as described earlier. The righthand side 1194 of FIG. 11c a virtual camera 1166 behind the first display and in a position relative to the location of the second colour video 1154 (eg, the video of the second user) on the first display 1153 that corresponds with the position of the second user 1151 relative to location at which the first transformed colour frame 1162 (eg, the transformed video of the first user) will be displayed on the second display 1161. In this way, the first transformed colour frame that is displayed on the second display 1161 should replicate for the second user 1151 the view that they would have if they were positioned behind the first display 1153 and looking through a hole in the first display 1153 that is the same size as the application window 1154.

In this example, the virtual camera 1166 position is set based on a 3D position of the second user 1151 relative to the location 1162 at which the first transformed colour frame (eg, the transformed current frame of the video of the first user) will be displayed to the second user 1151 on the second display 1161b. This 3D position of the second user 1151 may be determined using: the location of the second user 1151 in the current colour frame of the video captured by their real camera (i.e., their location within the second current colour frame); a depth 1165 of the second user 1151 from the second display 1161; the location 1162 at which the first transformed colour frame will be displayed on the second display 1161b; and a known position of the second real camera (i.e., the real camera that is capturing images of the second scene in which the second user 1151 is located) relative to the second display 1161b.

The location of the second user 1151 in the second current colour frame and the depth 1165 may together describe the second user's 1151 3D position relative to the second real camera. The location of the second user 1151 in the second current colour frame may be determined from performing object recognition on the image content of the second current colour frame, for example to identify features of the second user 1151 such as eyes, a nose, a mouth, ears, etc (using any known techniques, as explained earlier). The depth 1165 may be determined using a depth frame 102 that images the second scene, as described earlier with reference to FIGS. 5 to 7, for example from the depth value(s) for at least one pixel corresponding to the determined second user 1151 location, such as by using the depth value of a single pixel corresponding to the second user 1151 location (eg, a ‘nominal’ depth value) or by determining the average depth for at least some of the pixels corresponding to the determined second user 1151 locations.

With knowledge of the second user's 1151 3D position relative to the second real camera, the known position of the second real camera relative to the second display 1161b (for example, relative to a particular point of the second display 1161b, such as a corner or centre point of the second display 1161b) and the location 1162 at which the first transformed colour frame will be displayed on the second display 1161b can be used to determine the 3D position of the second user 1151 relative to the location 1162 at which the first transformed colour frame will be displayed on the second display 1161b. Similarly to the earlier explanation in relation to the first user 801, the position of the second real camera may be known from an earlier input of the second user 801 or from an earlier calibration, and may be stored in memory. Likewise, the location 1162 at which the first transformed colour frame will be displayed on the second display 1161b may be determined with known techniques, for example using existing UI managers or by known image detection processes on the data displayed by the first display 802 from known UI. In one implementation example, the position at which the preceding transformed colour frame in the transformed first video stream may be identified, which is then taken to be the location 1162 at which the first transformed colour frame will be displayed on the second display 1161b.

Finally, the position of the virtual camera 1166 can be set based on the determined 3D position of the second user 1151 relative to the location 1162 at which the first transformed colour frame will be displayed on the second display 1161b, and the location on the first display 1153 at which the second colour video 1154 is displayed. For example, the virtual camera 1166 may be positioned at a depth 1165c (i.e., distance in the z-direction) behind the first display 1153 that is the same as the depth 1165 at which the second user 1151 is positioned from the second display 1161. Alternatively, the depth 1165c may be a proportion of the depth 1165, where the proportion is determined by the relative size of the second colour video 1154 on the first display 1153 and the size of the first transformed colour video 1162 on the second display 1161 (for example, if the image of the second colour video 1154 is half the size of the image of the first transformed colour video 1162, then the depth 1165c may be half the depth 1165, and if the image of the second colour video 1154 is three times the size of the image of the first transformed colour video 1162, then the depth 1165c may be three times the depth 1165, etc). Likewise, the virtual camera may be positioned at a horizontal position (i.e, x-direction) and a vertical position (i.e., y-direction) relative to the second colour video 1154 on the first display 1153 that is the same as the horizontal and vertical positions of the second user 1151 relative to the first transformed colour video 1162 on the second display 1161 (or is at proportionally the same position if the second colour video 1154 on the first display 1153 is a different size to the first transformed colour video 1162 on the second display 1161).

Whilst this technique is described only with reference to setting the position of the virtual camera 1166 and generation of a first transformed colour frame to be displayed on the second display 1161b, it may also be used for setting the position of a second virtual camera using which a second transformed colour frame is generated, capturing the second in which the second person 1151 is positioned, to be displayed at location 1154 on the first display 1153. In this way, both the first user 1150 and second user 1151 may experience the same visual effect.

Regardless of whether this technique is used for setting the position of just virtual camera 1166, or also setting the position of a second virtual camera capturing the first user 1150, the example of FIG. 11 assumes that the first user 1150 and the second user 1151 are both positioned more or less directly in front of the video locations 1154 and 1162 on their respective displays 1154. As a result, the two displays may be thought of as being put “back to back” or on top of each other (for example, see FIG. 11b) with the second user 1151 effectively viewing the first user 1150 through an opening 1162b in the displays (and vice versa, if the same technique is being applied to capturing images of the first scene in which the first user 1150 is located). However, if positioning of the first user 1150 and/or second user 1151 is different to this, in some circumstances the second user 1151 may not properly see the first user 1151 in the first transformed colour frame. For example, if the second user 1151 is positioned well over to the right or the left and/or the top or the bottom, of the second display 1161, and/or the first user 1150 is positioned well over to the right or the left and/or the top or the bottom, of the first display 1153, the first transformed colour video 1162 presented on the second display 1161 may not actually capture the first user 1150.

To address this, a further translation and/or rotation may be applied when positioning the virtual camera 1166. In particular, as described above, the position of the first virtual camera 1166 is set based on the location on the first display 1153 at which the second colour video (or second transformed colour video) 1154 is displayed to the first user 1150, and the location of the second user 1151 within the second current colour frame of the second plurality of time consecutive colour frames. In addition to that, it may be set based on a matrix defining a relationship between the location of the first user within the first scene and the location of the second user within the second scene (for example, their locations relative to the positions of the displayed videos 1154 and 1162, which can be determined as explained earlier). The matrix may define an amount of rotation (in the x and/or y axis) and/or an amount of translation (in the x and/or y and/or z axis) that should result in the first transformed colour video 1162 capturing the first scene in a way that includes the first user 1150. It may be thought of as defining an amount of rotation and/or translation of the second display 1161 relative to the first display 1160 in the visualisation of FIG. 11b (rather than positioning them on top of each other as shown in FIG. 11b) that should result in the first transformed colour video 1162 capturing the first scene in a way that includes the first user 1150. As such, it may be seen as a matrix that defines a relationship between the first scene captured by the first camera and the second scene captured by the second camera. The matrix may be determined in a variety of different ways, for example algebraically based on the geometric relationship of the location of the first user within the first scene and the location of the second user within the second scene, or through trial and error by adjusting the matrix until the first user 1150 is positioned correctly within the first transformed colour video 1162 (for example, until they are positioned within a predetermined acceptable distance of a predetermined location within the first transformed colour video 1162, such as the centre of the first transformed colour video 1162).

The use of this matrix may result in an additional rotation and/or translation of the first virtual camera 1166 (for example, in FIG. 11c, the position of the virtual camera 116 may be translated left or right and/or up or down, and/or rotated in the x and/or y axis direction).

The matrix defining the relationship between the location of the first user within the first scene and the location of the second user within the second scene may be set only when the video call is initiated, so that at the start of the call the positioning of the first virtual camera 1166 is set in a way that results in the first user 1150 appearing within the first transformed colour video 1162. Alternatively, it may be set when the video call is initiated, and either intermittently or continually updated. Furthermore, the matrix may be set automatically or based on input from the first and/or second user, for example to adjust the location of the first virtual camera 1166 until the second user 1151 is happy with how the first scene is being presented in the first transformed colour video 1162.

Regardless of how regularly the matrix defining the relationship between the location of the first user within the first scene and the location of the second user within the second scene is set (or indeed whether such a matrix is used at all), setting the position of the virtual camera 1166 based on the position of the second user 1151 and then transforming the current frame of the first colour video stream may be repeated for each new frame of the first colour video stream. As a result, the video stream displayed on the second user's display will appear to capture the first scene (and therefore the first user 1150) from the perspective of the virtual camera 1166. By automatically setting the position of the virtual camera 1166 in this way, whenever the second user 1166 moves relative to the first transformed colour video 1162 on the second display 1161, their perspective of the first scene may change in a natural, intuitive way, almost as if they were looking through an opening or hole in the second display 1161, into the first scene in which the first user 1150 is located. As a result, they may be able to get a better view of a part of the first user 1166 or something else in the first scene simply by moving around in an intuitive way, which may be particularly useful in an education setting, or for remote healthcare or diagnosis.

Optionally, the field of view (angle of view) of the virtual camera 1166 may also be set in dependence on the 3D position of the second user 1151 relative to the first transformed video stream 1162b on the second display 1161b, or in dependence on the 3D position of the virtual camera 1166 relative to the second colour video 1154 on the first display 1153. As can be appreciated from FIG. 11a, as the second person 1151 moves relative to the first transformed video stream 1162 on the second display 1161, the angle 1163 and view 1160 change. The angle 1163 may be determined mathematically (for example, using trigonometry) from the 3D position of the second user 1151 relative to the first transformed video stream 1162b on the second display 1161b. Likewise, the same angle 1163 may alternatively be determined mathematically (for example, using trigonometry) from the 3D position of the virtual camera 1166 relative to the second video stream 1154 on the first display 1153. The 3D position of the second user 1151 relative to the first transformed video stream 1162b on the second display 1161b may be determined as described above, and likewise the position of the virtual camera 1166 and the second video stream 1154 on the first display 1153 will be known as explained above. The angle 1163c and field of view 1156c of the virtual camera 1166 may be set to be equal to the determined angle 1163 and view 1160. By setting the field of view 1156c in this way, the realism of the experience for the second user 1151 may be even further enhanced.

Additionally or alternatively, as part of setting a position for the virtual camera 1166, the rotation of the virtual camera 1166 may also be set based on the 3D position of the second user 1151 relative to the location at which the first transformed colour video 1162b is displayed to the second user 1151 on the second screen 1161b. By knowing this 3D position of the second user, it is possible to determine the rotation of the second user 1151 in order to look at the first transformed colour video 1162b on the second screen 1161b (for example, to look at the centre of the first transformed colour video 1162b on the second screen 1161b). The rotation of the virtual camera 1166 can be set to be the same as that of the second user 1151, which even further improves the accuracy with which the virtual camera 1166 replicates the view/perspective of the second user 1151, and therefore even further enhances the realism of the effect experienced by the second user 1151 when viewing the first transformed colour video 1162b.

Additionally or alternatively, as part of setting a position for the virtual camera 1166, the translation of the virtual camera 1166 in the x and/or y direction may also be set, for example using the principle point of the camera. Cameras typically have a camera intrinsic matrix, which includes a principle point. This is normally set to the middle of the camera system, meaning that the camera is imaging directly in front of what it is looking at. However, it can be set to something different, meaning that the camera is then imaging with an offset in the x and/or y direction. Effectively, this creates a pan in the image. Therefore, by setting the principle point for the virtual camera 1166, the position of the virtual camera 1166 may effectively be translated in the x and/or y direction). As will be understood by the skilled person, the position of the second user 1151 in 3D space relative to the first transformed colour video 1162b on the second screen 1161b may be described using a pose matrix containing transition and rotation information about the second user 1151 relative to the coordinate system of the display, and likewise the position of the virtual camera 1166 in 3D space relative to a reference point, for example relative to the first real camera 1155 or the location of the display of the second colour video 1154 on the first display 1154 (these are effectively analogous, since the relative location of the first real camera 1155 and the second colour video 1154 on the first display 1154 is known, so a pose matrix describing the position of the virtual camera 1166 relative to one of them also implies the position of the virtual camera 116 relative to the other of them).

A pose of an object is understood as the location and orientation (rotation) of the object in the scene, i.e. relative to a reference and coordinate system. A pose matrix indicates a translational position and the rotational position (i.e., orientation) of an object relative to a reference. In particular, the pose matrix indicates the translational position in each of the x, y and z planes, relative to the reference coordinate system. The pose matrix also indicates a rotational position (i.e. orientation) of the object about each of the x, y and z axes, relative to the reference coordinate system. The pose matrix may be considered as a 6D pose matrix. For example, the pose matrix may be a 4×4 matrix, made of a 3×3 rotational component indicative of the rotational position of the object relative to the fixed reference coordinate system, and a translational component indicative of the translational position of the object relative to the fixed reference.

The determined position of the 3D position of the second user 1151 relative to the location at which the first transformed colour video 1162b can be described with a pose matrix. This can be used to define a pose matrix that describes the position of the virtual camera 1166 relative to the display of the second colour video 1154 on the first display 1153. For example, the two pose matrices may be the same, with the depth displacement 1165c of the pose matrix for the virtual camera 1166 set to be behind the first display 1154, or if the size of the second colour video 1154 is different to that of the first transformed colour video 1162b, the pose matrix for the virtual camera 1166 may be an appropriately scaled version of the pose matrix that describes the position of the second user 1151.

Furthermore, as will be understood by the skilled person, the position of the virtual camera may also comprise an intrinsic matrix, which defines the field of view of the virtual camera in the x and y axis, and where the centre of the image captured by the virtual camera is.

Having defined the position of the virtual camera relative to a reference whose position relative to the first real camera is known (for example, the position of the virtual camera may be defined by a pose matrix and intrinsic matrix that describes its position relative to the first real camera 1152a itself, or relative to the location of the second colour video stream on the first display, whose position relative to the first real camera is known), the required transformation of the current frame of the first colour video stream may be determined. The required transformation may be determined using a pose matrix and intrinsic matrix of the first real camera (which may be know from earlier user input or calibration, as described earlier) and the pose matrix and intrinsic matrix of the virtual camera. For example, the intrinsic matrix of the real camera can be used to convert each pixel in the current colour frame to a 3D ‘world’ space (for example, a space measured in metres). By way of non-limiting example, a pixel at location x=7 and y=12 may be transformed using the real camera intrinsic matrix to a point that is 40 cm (in the x direction) and 80 cm (in the y direction) away from the reference point. That real world point may then be transformed using the pose matrices of the real camera and the virtual camera (for example, by comparing the two matrices) to a transformed real world position, such as 50 cm (in the x direction) and 95 cm (in the y direction). Finally, the transformed real world position can be converted to a pixel position, such as x=18 and y=21, in the transformed current colour using the intrinsic matrix of the virtual camera.

Whilst the example ways of defining the position of the virtual camera and how that can be used to determine the required transformation are described particularly with reference to the implementation of FIG. 11, it will be understood that they may equally be used for any of the other implementations described herein, such as those of FIGS. 8 to 10. For example, with reference to FIG. 8, a pose matrix may be used to describe the position of the virtual camera 811 relative to the first real camera 803. Because the virtual camera 811 may always be positioned on the surface of the first display 802, one of its translational dimensions (eg, the depth, z, dimension) may always be the same. Furthermore, in some examples, the rotational components of the virtual camera pose matrix may be the same of those of the real camera pose matrix, or may be set to be different (as described in more detail below). Furthermore, intrinsic matrices may not be required for the examples of FIGS. 8 to 10, since the described field of view of the virtual camera 811 may be the same as that of the first real camera 803, although they may nevertheless be used for achieving x and/or y translations by setting the principle point appropriately.

FIG. 12 shows an example of how the rotational angle of the virtual camera 811 may be adjusted based on the location of the first user 801 within the current frame of the first colour video captured by the first real camera 803 (note, the same effect may also be achieved by adjusting the principle point of the virtual camera). The leftmost diagram 1290 in FIG. 12 shows a top down view of the arrangement 810 in FIG. 8. The first real camera 803 has an angle of view 1157 and a field of view 1156. The first user 801 is at a depth 1251 from the first display 802 and first real camera's field of view of a centre point 1254a. The image captured by the first real camera 803 includes part of the wall 1152 behind the first user 801. The box 1250 shows the location of the second user 806 within the second video stream 804 presented on the first display 802.

The middle diagram 1291 of FIG. 12 shows the virtual camera 811 positioned over image of the second user 806 on the first display. The first real camera is not shown in this diagram for the sake of clarity. The virtual camera 811 has a field of view 1156 that is the same as that of the first real camera 803. The rotation of the virtual camera 811 is the same as that of the first real camera 803, with its translational position being different. As such, the virtual camera 811 can be said to have panned from the position of the first real camera 803 and the centre point 1254b of the field of view 1156b is offset 1253 from that of the first real camera 1254a. As can be seen, the first user 801 was relatively central in the field of view 1156, but is now off to one side of the field of view 1156b. As a result, in more extreme cases, particularly if the first user 801 moves a little, some or all of the first user 801 may be out of shot from the perspective of the virtual camera 811.

The rightmost diagram 1292 shows a solution to this issue, where setting the position of the virtual camera 811 includes setting a rotation of the virtual camera 811 so that the location of the first user 801 in the first transformed colour frame will match the location of the first user 801 in the current colour frame of the first video stream captured by the first real camera 811. As can be seen, the set rotation results in a field of view 1256c with a centre point 1254c. The centre point 1254c is rotated by an angle 1252 compared with the centre point 1254b and results in the same or similar part of the first user 801 appearing in the centre of the transformed first video as the part of the first user 801 appearing in the centre of the first video captured by the first real camera 803. The rotational angle 1252 may be determined from trigonometry using the depth of the first user 801 from the first real camera 803 (which may be determined in any suitable way, for example using a depth frame 102 as described earlier) and the offset distance 1253. The offset distance 1253 may be determined from the translational position of the virtual camera 811 relative to the first real camera 803. Therefore, the rotational position of the virtual camera 811 may thus be defined by starting with the known rotational position of the first real camera 803 and adjusting it by an amount equal to the determined angle 1252. Whilst we have described this in relation to only one rotational angle (eg, rotation around the y axis, which equates to left/right rotation or tilt) it may also be performed in relation to another rotational angle (eg, rotation around the x axis, which equates to up/down rotation or tilt).

As a result, the location of the first user in the transformed colour frame (that images the first scene from the perspective of the virtual camera 811) should match that of the current frame of the first video stream. By “match”, we mean that they should as closely as possible appear in the same area of the two frames, for example to within 10%, or 5%, or 2% or 1%. A part of the first user 801 imaged by a pixel in the current frame of the first colour video stream should be imaged by the same pixel in the transformed colour frame, or by a pixel within an acceptable distance, for example by a pixel no more than 20, or 10 or 5 pixels away.

In addition, or as an alternative, to using camera rotation, pan and/or zoom, and crop, may be applied to the transformed colour frame so that the location of the first user in the transformed colour frame matches that of the current frame of the first video stream. For example, the transformed colour frame may be panned in the x and/or y directions by an amount that should result in the location of the first user in the transformed colour frame matching that of the current frame of the direct video stream. The amount of pan may be determined based on the depth of the first user 801 from the first display 802 and the offset distance 1253. The resultant image may then be cropped to remove empty pixels and return the aspect ratio to the correct ratio.

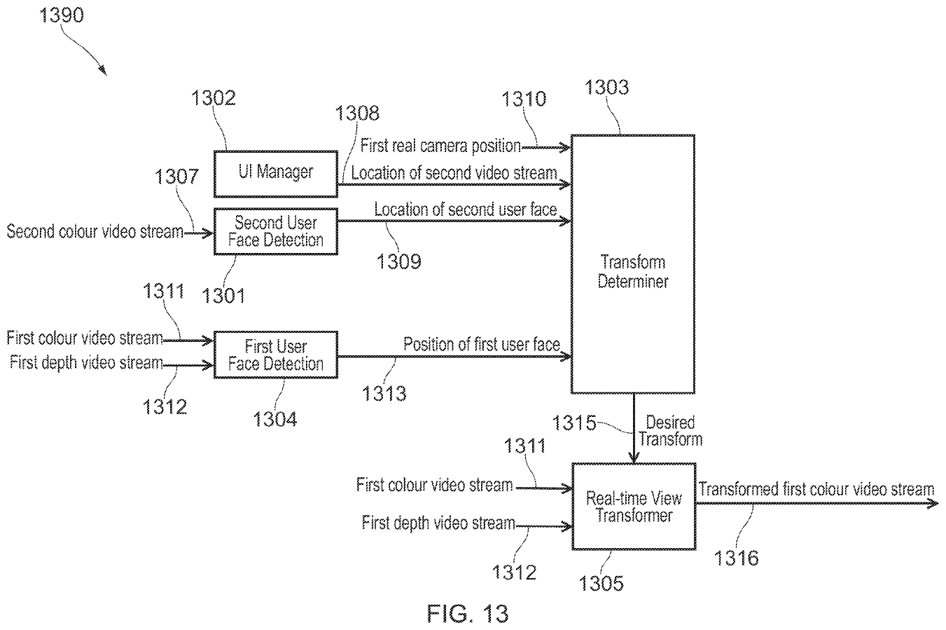

FIG. 13 shows an example functional system 1390 for determining and performing a transformation of the first colour video stream 1311 in accordance with the aspects described above with reference to FIG. 12. It is configured to determine the transform 1315 to be applied to the first colour video stream 1312 (and optionally also applied to the first depth video stream 1311) by the view transformer 1305 to generate the first transformed colour video stream 1316 (and optionally also a first transformed depth video stream). The first colour video stream 1311 and the first depth video stream 1312 may be the same as the colour frames 101 and depth frames 102 described earlier with reference to FIG. 5 to 7. Likewise, the view transformer 105 may be the same as the video processors 105, 105-5, and the transformed first colour video stream 1316 may be the same as the transformed colour frames 104. Finally, the generated desired transform 1315 may be the same as the desired transform 103, 103a. Therefore, FIG. 13 provides some details of a focus of the present disclosure—the generation of the desired transform data 1315—which is then used by a functional module/unit 1305 that is not the focus of the present disclosure (and may be configured to operate in any suitable way, for example in accordance with the explanations earlier in this disclosure). As also explained earlier, the desired transform data 1315 may take the form, for example, of a transformation matrix that describes a multi-dimensional (for example, translational and rotational) transformation to be applied to the current frame of the first colour video stream.

The transform determiner 1303 may receive data 1310 indicative of the position of the first real camera 803, which may, for example, be stored in memory after an earlier user input or calibration process (as explained earlier). It may also receive data 1308 indicative of the location of the second video stream 804 on the first display 802. This may be received from a UI manager 1302 that is part of a first electronic device, such as a first computer or mobile device, that is outputting the second video stream 804 to the first display 802. The transform determiner may also receive data 1309 indicative of the position of the second user 806 in the second video stream. This may be generated using a face detection function/algorithm 1301 that operates on the current frame of the second colour video stream 1307. Optionally, the face detection function/algorithm 1301 may also receive a second depth video stream providing depth data relating to the second scene in which the second user is located, and use that as part of its detection of the second user. Further optionally, the face detection function/algorithm 1301 may be part of the transform determiner 1303. Using these data, the translational position of the virtual camera 811 may be set.

In one example implementation, the transform determiner 1303 may determine the desired transform 1315 simply based on the translational position of the virtual camera 811 relative to the position first real camera 803. This would result in the example shown in the middle diagram 1291 of FIG. 12. Optionally, if it is desired for the location of the first user 801 in the transformed first video stream to match their location in the first video stream, pan and/or zoom and cropping may be applied as part of the transformation, or to the transformed first colour video stream 1316, in order to reposition the first user 801 in the transformed frames.

Alternatively, the transform determiner 1303 also receives data 1313 indicative of the 3D position of the first user 801 in the first video stream. This may be determined by a first user face detection algorithm/function 1304 that performed image recognition on the first colour video stream 1311 to locate the first user 801 within the image, and uses the first depth video stream 1312 to determine the depth to the first user 801. The transform determiner 1303 may then determine the rotational position of the virtual camera 811 and set a rotation transformation in the desired transform data 1315. This would result in the example shown in the leftmost diagram 1292 of FIG. 12.

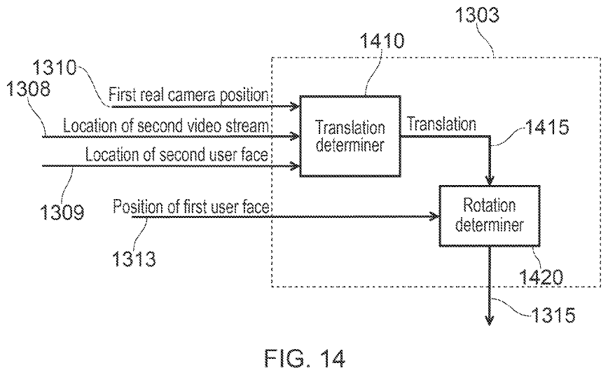

FIG. 14 shows some further example details of the transform determiner 1303. In this example, the transform determiner 1303 comprises a translation determiner module/function 1410 that is configured to determine the required translational transformation 1415 based on the known first camera position 1310 and the position of the first virtual camera 811 (which is determined using the location of the second video stream 1308 and the location of the second user's face 1309 within the second video stream, as explained earlier). The required translational transformation 1415 may, for example, be a transform matrix comprising x, y and z translation values.

The rotation determiner module/function 1420 may receive the required translational transformation 1415 and add to it rotational transformation values in order to complete the desired transform 1315. For example, it may determine x and y (and optionally also z) axis rotational values based on the determined position of the first user 1313, as explained earlier with reference to FIG. 12. The output desired transform may therefore be a transformation matrix that describes a 3D translational and rotational transformation, as described earlier. Optionally, the rotation determiner 1420 may also receive the first real camera position data 1310 in order to determine a difference between to the rotational position of the first user and the first camera, or the translation data 1415 may include the first camera rotational data, or the first user position data 1313 may identify the rotation of the first user's head with reference to the rotational position of the first real camera.

In an alternative, the rotation determiner 1420 could be a pan/zoom and crop determiner, configured to determine an amount of pan and/or zoom and crop to be applied in the transformation so that the first user's location in the transformed colour frame matches their position in the current frame of the first colour video. In a further alternative, the rotation determiner 1420 may be omitted and the pan and/or zoom and crop may be applied to the transformed colour video frame 1316.

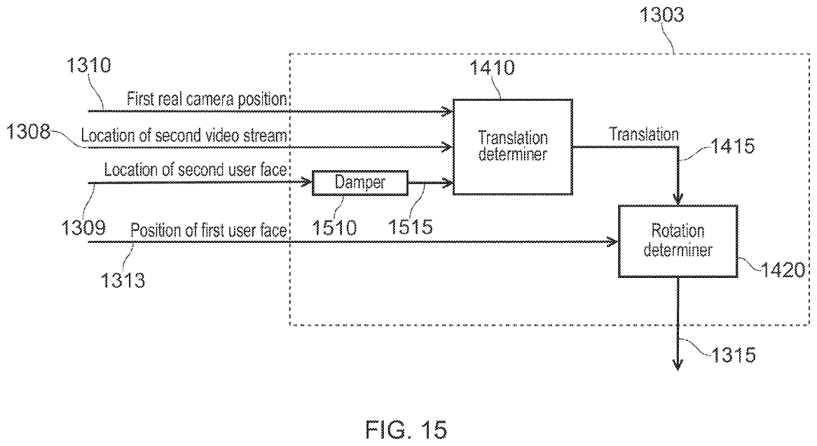

FIG. 15 shows a further alternative implementation of the transform determiner. This implementation comprises a damper 1510, which may be any suitable type of damping, or integrating, or filtering function configured to generate output a modification of the second user face location 1515. In some instances, it may be desirable for the position of the first virtual camera 811 not to change immediately when the second use 805 moves within the second scene. For example, if the second user 805 is regularly moving, immediately responding with a change in virtual camera 811 position may be disorienting or distracting for the first user 801. Therefore, the damper 1510 can perform a filtering or integrating function that effectively retains knowledge of the second user's location within one or more preceding frames of the second video stream that precede the current frame of the second video stream on which the transformation will be applied. The damper 1510 may therefore modify the second user location data 1309 based on their location in one or more preceding frames so as to dampen or reduce the amount of translation applied in the transformation if the second user 806 is moving. Consequently, the rate of change of first virtual camera 811 position may be reduced, thereby improving the experience of the first user 801.

In this example, no damping is applied to any other inputs that affect the transformation of the current frame of the first colour video stream. Therefore, the system may still quickly respond to those, for example quickly responding if the first user 801 moves the location of the second video stream 804 on the first display 802. However, in an alternative, the damper may be positioned elsewhere, for example operating on the transform data 1315, or the translation data 1415, so that the rate of change of those data may be reduced instead.

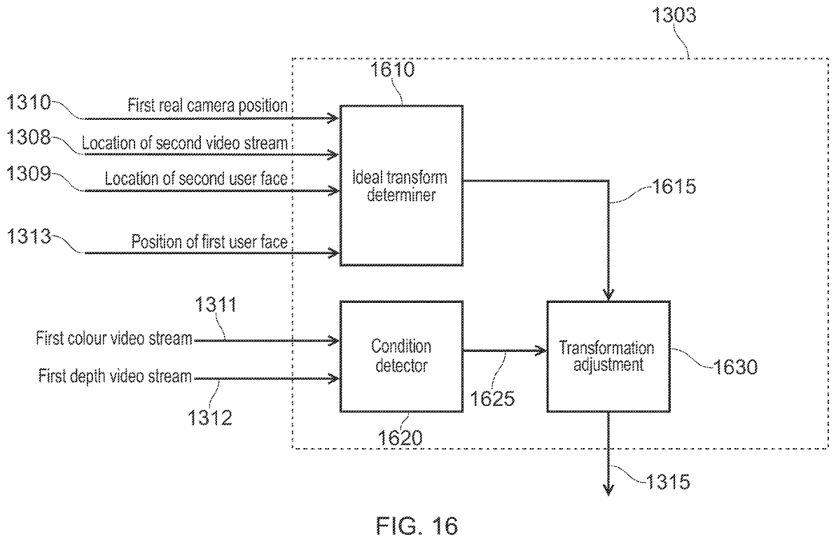

FIG. 16 shows a further example implementation of the transform determiner 1303. In this example, it comprises an ideal transform determiner 1610 configured to determine and output an ideal transform 1615. The ideal transform determiner 1615 may comprise the transform determiner functions described earlier with reference to FIGS. 13 to 15. As such, the ideal transform 1615 may be a transformation matrix that describes the transformation required for the transformed second colour video to appear to capture the first scene from the perspective of the virtual camera 811. However, it has been recognised that there are some conditions in which applying the ideal transform 1615 may cause a poor quality result in the transformed frame of the first colour video. One such example is if the first user 801 rotates their head a long way away from the first real camera 803, for example to look at something behind them. This can result in the transformed colour frame including may issues and having a poor visual appearance, in some instances failing to render the first user's head at all in the image, which would leave a hole in the image where their head should be. This might occur when the system does not have enough knowledge of what a transformed view of the first user's head should look like when they have rotated their head by an unusual amount. However, the inventors have recognised that in this scenario it may not be necessary to apply a transformation at all, since the purpose of the transformation is typically to create the appearance for the second user that when the first user is looking in the direction of the image of the second user 806 on the first display 802, they appear on the second display to be looking in the direction of the second user themselves. If the first user 801 has turned to look a long way away from the second user's image 806, the second user's experience when looking at the second display is much the same regardless of if they are viewing the untransformed first colour video or a perfect transformation of the first colour video. Therefore, in such scenarios the transformation may be turned off.

For this purpose, the transform determiner 1303 may comprise a condition detector 1620 configured to determine whether a transformation adjustment condition has been met. The condition detector 1620 may be configured to detect one or more different types of condition. One example condition is a pose condition, which relates to the pose of the first user 1311 within the first scene. The condition detector may determine a pose of the first user, for example an amount of rotation around at least one axis (for example, relative to reference such as the pose of the first real camera 803). The magnitude of the determined pose may then be compared against a disablement threshold and, if it is greater, the condition detector 1620 may output a signal 1625 indicating that the transformation should be disabled. In more detail, each determined angle in the pose may be considered in turn. For example, rotation of the head of the first user 801 around the x axis may be determined. The rotation may be either positive or negative depending on which way the first user's head is turned. The magnitude of the determined pose is then compared against the disablement threshold and, if it is greater, the signal 1625 may indicate that no transformation should be applied to the current frame of the first video stream, or at least no x axis transformation should be applied. The same may take place in relation to y axis rotation, the magnitude of which may be compared against the same or a different disablement threshold, and if it is exceeded, the signal 1625 may indicate that no transformation should be applied to the current frame of the first video stream, or at least no y axis transformation should be applied. The transformation adjustment 1630 module/function may then generate the desired transformation 1315 (eg, the transformation matrix) by modifying the ideal transformation 1615 accordingly. For example, is the first user 801 has turned to look a long way to the left and slightly up, it may be determined that left-to-right transformation should be turned off (eg, removed by the transformation adjustment nodule 1630) and the up-to-down transformation should be kept in the desired transformation 1315.

Optionally, the condition detector 1620 may also compare the magnitude of the determined pose (or one or more of the angled in the determined pose) against a reduction threshold that is smaller in magnitude than the disablement threshold. For example, the disablement threshold may be 30 degrees and the reduction threshold 20 degrees. If the magnitude of the determined pose is between the disablement threshold and the reduction threshold, the signal 1625 may indicate where between the two thresholds the pose is (for example, a percentage value of where it is between the two thresholds). The transformation adjustment module 1630 may then proportionally adjust the amount of transformation based on where the determined pose is between the two thresholds. This may be performed on an axis by axis basis, such that an x axis rotation with a magnitude between the thresholds results in a proportionate reduction in transformation in the x axis. In this way, the amount of applied transformation may be gradually reduced so that it is not noticeable to the second user in the transformed first video stream.

In more detail, the transformation matrix may comprise six values—x, y and z translation values describing the translational transformation from the real camera to the virtual camera, and x, y and z axis rotation values describing the rotational transformation from the real camera to the virtual camera. When the magnitude of the determined pose is less than the reduction threshold, the transformation adjuster 1630 may set the desired transform 1315 to be the same as the ideal transform 1615. However, when the magnitude of the determined pose is between the reduction threshold and the disablement threshold, the desired transformation 1315 may be set by reducing at least part of the ideal transformation 1615. For example, if the magnitude of the determined pose is halfway between the reduction threshold and the disablement threshold, the x, y, z translation and rotation values of the desired transformation 1315 may be set to 50% of the ideal transformation values. If the magnitude of the determined pose is ⅕ of the way from the reduction threshold to the disablement threshold (for example, if the reduction threshold is 10 and the disablement threshold is 20, the determined pose is 22), the ideal transform 1615 may be reduced by ⅕ to generate the desired transform 1315, i.e., the x, y, z translation and rotation values of the desired transformation 1315 may be set to 80% of the ideal transformation values. If the magnitude of the determined pose is 9/10 of the way from the reduction threshold to the disablement threshold (for example, if the reduction threshold is 20 and the disablement threshold is 40, the determined pose is 38), the ideal transform 1615 may be reduced by 9/10 to generate the desired transform 1315, i.e., the x, y, z translation and rotation values of the desired transformation 1315 may be set to 10% of the ideal transformation values, etc. Whilst in these examples all of the values of the ideal transform 1615 are reduced, in an alternative any one or more may be reduced to generate the desired transform 1315 with the remaining values in the desired transform 1315 being the same as those of the ideal transform 1615. For example, if the magnitude of the determined y-axis pose is between the reduction threshold and the disablement threshold, whilst the magnitude of the x-axis pose is less than the reduction threshold, values relating to y-axis transformation in the ideal transformation 1615 may be reduced to generate the desired transformation 1315, whereas other transformation values may remain the same. Thus, it can be seen that each value of the ideal transformation 1615 may be independently adjusted based on a comparison of each determined pose of the first user against the reduction threshold and the disablement threshold. The amount of adjustment or reduction may be based on the magnitude of the determined pose relative to the reduction threshold and the disablement threshold. For example, the reduction threshold may define the lower limit of a range and the disablement threshold may define the upper limit of the range. The amount of reduction applied to the transformation may depend on where the magnitude of the determined pose is in the range, where more reduction is applied as the magnitude of the determined pose increases towards the disablement threshold. In one particular example, the amount of reduction may be proportional (for example, linearly, or directly, proportional) to where the magnitude of the determined pose is in the range, with no reduction being applied when the magnitude of the determined pose is equal to the reduction threshold and full reduction (eg, disablement) being applied when the magnitude of the determined pose is equal to the disablement threshold, and 30% reduction applied when the magnitude of the determined pose is 30% of the way from the reduction threshold to the disablement threshold (i.e., 30% of the way up the range). However, in an alternative, rather than the reduction being proportional, the amount of reduction may change in any other suitable way based on where the magnitude of the determined pose is in the range. For example, the range may be split into discrete sub-ranges each having a fixed amount of reduction, for example a 10% reduction being applied when the magnitude of the determined pose is in the sub-range of 0-20% up the range, a 30% reduction being applied when the magnitude of the determined pose is in the sub-range of 20-40% up the range, etc.

The skilled person will readily appreciate how the pose of the first user 801 may be determined using the current frame of the first colour video stream 1311 and optionally also the current frame of the first depth video stream 1312, so it is not described in detail here.

Additional or alternative conditions that may be detected by the condition detector 1620 include:

A proximity condition. In this, the proximity (or depth) of the first user 801 to the first real camera 803 may be determined, for example from the first depth video stream 1312. If it is determined to be less than a proximity threshold (i.e., the first user 801 is determined to be close to the first real camera 803), the condition may be met and the signal 1625 may indicate that transformation should be turned off. Optionally, if the determined depth is between the proximity threshold and an adjustment threshold that is greater than the proximity threshold, the signal 1625 may indicate where it is between the two thresholds (eg, in percentage terms). The transformation may then be reduced in proportion to where the depth is between the two thresholds.

A distance condition. In this, the proximity (or depth) of the first user 801 to the first real camera 803 may be determined, for example from the first depth video stream 1312. If it is determined to be greater than a distance threshold (i.e., the first user 801 is determined to be far away from the first real camera 803), the condition may be met and the signal 1625 may indicate that transformation should be turned off. Optionally, if the determined depth is between the distance threshold and a further adjustment threshold that is less than the distance threshold, the signal 1625 may indicate where it is between the two thresholds (eg, in percentage terms). The transformation may then be reduced in proportion to where the depth is between the two thresholds.

By considering the proximity condition and distance condition, the desired transformation 1315 may be improved since transformations where the imaged user is very close or very far away from the real camera may often include errors.

A position condition. In this, the proximity of the first user 801 to the edges of the captured scene may be determined, for example from the first colour video stream 1311 and/or first depth video stream 1312. If it is determined that the first user 801 is out of shot, or the distance between their position and an edge of the captured scene (eg, an edge of the colour video frame) is less within an edge threshold of an edge of the shot (eg, is very close to an edge of the shot, such as the top, bottom, left side or right side of the shot), the condition may be met and the signal 1625 may indicate that the transformation should be turned off. Optionally, if the determined position is between the edge threshold and an adjustment threshold that is greater than the edge threshold (eg, the user is somewhere approaching an edge of the shot, but not yet close enough to be within the edge threshold), the signal 1625 may indicate where the user is between the two thresholds (eg, in percentage terms). The transformation may then be reduced in proportion to where the user's position is between the two thresholds.

A compute resource condition. In this, the condition detector 1620 may determine the amount of compute resource available on one or more computing devices on which at least part of the transformation determination and execution processes are carried out. It may do this in any suitable way, for example receive relevant information from any appropriate software manager. If it is less than a compute threshold, the condition may be met and the signal 1625 may indicate that transformation should be turned off. This may help the system overall because if there is only limited compute resource available, the system may struggle to perform the transformation quickly enough, which will then interfere with the communication between the first and second user. In that case, it may be preferable for no transformation to be applied.

An object condition. In this, the condition detector 1620 may perform object recognition on the content of the current frame of the first colour video stream 1311, for example using any standard object recognition algorithms/software. If an object is identified that cannot be classified, or if an object is identified and is on a predetermined black list (for example, a list of types of object such as animals), then the condition is met. Unclassifiable objects, or objects on a black list, may cause problems in the determination of an accurate desired transformation, or may cause poor results in the transformed first video stream, in which case it may be preferable not to perform the transformation.

A calibration condition, which is met if it is detected that the first real camera 801 has moved position by an amount that voids the system calibration (eg, that voids the previously known position of the first real camera 801, that was known from earlier user input or calibration). Such a change in camera position may result in inaccuracies in the desired transformation 1315, causing poor results in the transformed first colour video. In these cases, it may be preferable not to perform the transformation.

A user absence condition, where if no user is detected within the captured shot), the condition may be met and the signal 1625 may indicate that the transformation should be turned off.

Optionally, where different parts of the first scene imaged by the first real camera 803 are at different depths, they may be transformed separately. For example, the current colour frame of the first colour video stream 1311 may have at least two areas, the first imaging a part of the scene that is within a first depth range (for example, a foreground depth range) and the second imaging a part of the scene that is within a second depth range (for example, a background depth range). The transform determiner 1303 and the view transformer 1305 may identify the areas in any suitable way, for example using the current frame of the first colour video stream 1311 and/or the first depth video stream 1312. A separate desired transform may be determined for each area by the transform determiner 1303 and then applied to the corresponding area by the view transformer 1305. In this case, the transformation adjustment described above may be performed for each area separately, such that transformation may be disabled or reduced for one area but continue for the other. Additionally or alternatively, all of the different transformation determination and execution processes described above may be performed on only one area, most particularly on the areas in the foreground depth range, with the other areas left untransformed. This may be performed because typically the first user 801 is likely to be in a foreground depth range, and transformation of the image of the first user 801 alone may be sufficient to achieve the desired effect. For example, when the determined pose off the first user is between the reduction threshold and the disablement threshold, at least part of the transformation applied to the image of the first user (most likely the transformation applied to the foreground parts of the scene) may be reduced as explained earlier, whilst the transformation applied to other parts of the image may remain unaltered. Thus, the same visual effect for the second user viewing the transformed first colour video stream may be achieved with reduced computing power.

In the above explanation of FIG. 16, disabling at least part of the transformation takes place by the transformation adjustment module/function 1630 removing or cancelling at least part of the ideal transformation 1615. This may particularly be the case if only part of the transformation is disabled (for example, x-axis or y-axis transformation). In an alternative, if the entire transformation functionality is to be disabled (for example, because the compute condition is met), the real-time view transformer 1305 may be disabled and the first colour video stream 1311 be communicated to the second user without any modification.

Optionally, the first user 801 and/or second user may be notified that the transformation is being adjusted, particularly if it is being disabled entirely, and may or may not be informed of the reasons why, for example so that they can take action to resolve the issues. This may take the form of, for example, a pop up or other type of message on their display.

The transform determiner 1303 described above with reference to FIGS. 13 to 16 is particularly configured to position the virtual camera as described with reference to FIGS. 8 to 10 and 12. However, in an alternative it may be configured to position the virtual camera as described with reference to FIG. 11. In this case, the second user face detection 1301 may additionally receive a second depth video stream imaging the second scene and may output to the transform determined 1303 data indicative of the 3D position of the second user relative to a fixed reference (such as relative to the second real camera). A UI Manager, or similar, on the second user's computing device may also output to the transform determiner 1303 data indicative of the location of the first video stream on the second display, so that the transform determiner 1303 can determine the 3D position of the second user relative to the first video stream on the second display. In this example, optionally the first user face detection 1304 may be omitted since it is not required for setting the position of the virtual camera. However, in some implementations it may be included and the transform determiner 1303 may include a condition detector 1620 and transformation adjuster 1630, where the position of the first user is used to determine if the transformation should be adjusted.

The system 1390, eg the transform determiner 1303 and view transformer 1305 (and any other associated functions/modules such as the first user face detection 1304 and second user face detection 1301), may be implemented on the first computing device associated with the first user (analogous to the arrangement of FIG. 3), or the second computer device associated with the second user, or elsewhere, such as in the cloud (analogous to FIG. 4). Alternatively, the functionality of the system 1390 may be executed across two or more of the first computing device, the second computing device and the cloud.

Implementing the system 1390 on the first computing device would be effective, but in some scenarios it may result in lag. For example, if the virtual camera is position to track the location of the second user, there may be significant latency in passing to the first computing device data indicative of the location of the second user. For example, the position at which the first transformed video stream is displayed on the second display is relatively slow and does not change often. In contrast, the second user can move quickly, and there may be significant latency in the positional data of the second user being communicated from the second computing device to the first computing device. This would slow down the speed at which the virtual camera position can respond to second user movements. This may be particularly true for the implementation of FIG. 11 where the 3D position of the second user is required.

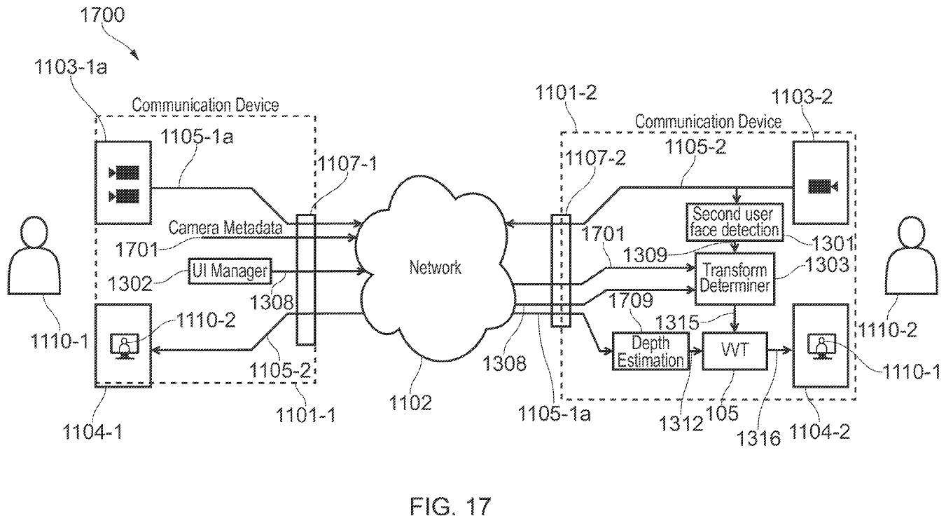

FIG. 17 shows an example 1700 where the functionality of the system 1390 is split between the first computing device 1101-1 and the second computing device 1101-2. In this example, there are two real cameras 1103-1a imaging the first user 1110-1, but it may alternatively be one real camera. In this example, the UI Manager 1302 is implemented on the first device 1101-1. As such, the first colour video stream 1105-1a, the metadata of the first real camera 1103-1a (eg, the known position of the first real camera and any other useful metadata, such as focal length) and data indicative of the location of the second colour video stream on the first display 1308 are all communicated to the second device 1101-2 via the network 1102. The second user face detection 1301 and the transform determiner 1303 are both implemented on the second device 1101-2. In this example, because the first depth video stream 1312 is determined from the two colour video streams output by the camera 1105-1a (both of which are represented with numeral 1105-1a), a depth estimator 1709 is used to generate the first depth video stream 1312. In an alternative, it may be implemented on the first device 1101-1 and communicated along with the colour video stream 1105-1a to the second device 1101-2. Furthermore, in this example the transform determiner 1303 does not include a rotation determiner 1420. However, in an alternative it may do, in which case the first user face detection 1304 may be implemented on the first device 1101-1 (if the first depth video stream is available on the first device 1101-1, for example because the depth estimation function 1709 is implemented on the first device 1101-1, or because the first real camera unit 1103-1a outputs the first depth video stream 1312), or it may be implemented on the second device 1101-2.

In this example, the majority of signal processing is completed in the second device 1101-2. This minimises the amount of data transfer, particularly data that is indicative of something that might be fast moving and require a fast response, such as the data indicative of the position of the second user. Consequently, the position of the virtual camera and therefore also the transformed video stream 1316 may respond more quickly to changes in the second user's position, which may improve the experience of the second user 1110-2 looking at the second display 1104-2.

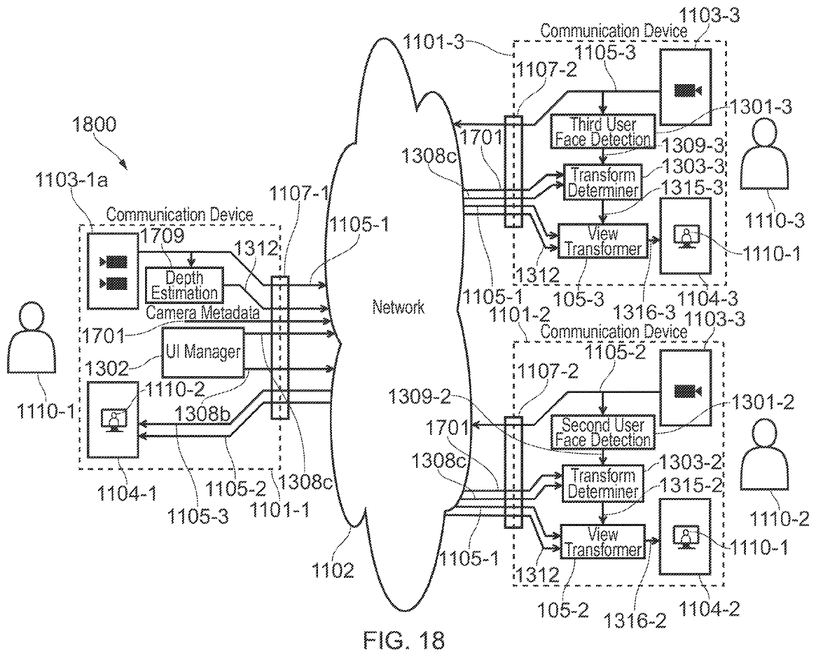

FIG. 18 shows an example of video communication between three participates-the first user 1110-1, second user 1110-2 and a third user 1110-3. In scenarios like this, the first virtual camera may be positioned to track the second user 1110-2 and the transformed colour video stream 1316b that is output for display on the second display 1104-2 may appear to capture the first scene from the perspective of the first virtual camera. A further virtual camera may be positioned to track the third user 1110-3 and the transformed colour video stream 1316c that is output for display on the third display 1104-3 may appear to capture the first scene from the perspective of the further virtual camera. Whilst the functionality of the second device 1101-2 shown in FIG. 17 may be replicated in the third device 1101-3, FIG. 18 shows an alternative that recognises that both the second and third devices both require the first depth video stream, so it may be preferable to generate that only once, in the first device 1101-1.

FIG. 18 shows an example of this, where the depth estimator 1709 is implemented on the first device 1101-1 and outputs the first depth video stream 1312 for communication to the second device 1101-2 and the third device 1101-3. The UI Manager 1302 outputs data 1308b indicative of the location of the second video stream 1105-2 on the first display 1104-1, which is communicated to the second device 1101-2. The UI Manager 1302 also outputs data 1308c indicative of the location of the third video stream 1105-3 on the first display 1104-1, which is communicated to the third device 1101-3. The transform determiner 1303-2 on the second device 1101-2 can then set the position of the first virtual camera based on the location of the second user in the second colour video stream 1105-2 and generate the desired transformation 1315-2. The transform determiner 1303-3 on the third device 1101-3 can set the position of a further virtual camera based on the location of the third user in the third colour video stream 1105-3 and generate the desired transformation 1315-3.

In an alternative to communicating the first colour video stream 1105-1 and the first depth video stream 1312 separately over the network 1102, the first device 1101-1 may generate and output volumetric data, which essentially combines the first colour video stream 1105-1 and the first depth video stream 1312 in a similar way to a point cloud.

In all of the examples above, the system may be configured to operate in real-time. The first real camera will capture the first scene at a particular frame rate, such as 24 Hz/fps or 50 Hz/fps, or 60 Hz/fps. This means that the signal processing system, for example the transform determiner 1303 and view transformer 1305 will receive a new frame at a rate determined by the frame rate of the camera. For example, if the frame rate is 24 Hz or 24 fps, a new frame will be received approximately every 42 ms, and if the frame rate is 60 Hz or 60 fps, a new frame will be received approximately every 16.7 ms, etc. Therefore, if the view transformer operates in real time, it must generate the desired transform within the inter-frame interval, for example within 42 ms or within 16.7 ms. By operating at this speed, the users may experience a seamless, real-time video conversation.

The aspects of the present disclosure described in all of the above may be implemented by software, hardware or a combination of software and hardware. Any electronic device or server can include any number of processors, transceivers, displays, input devices (e.g. mouse, keyboard, touchscreen), and/or data storage units that are configured to enable the electronic device/server to execute the steps of the methods described herein. The functionality of the electronic device/server may be implemented by software comprising computer readable code, which when executed on the processor of any electronic device/server, performs the functionality described above. The software may be stored on any suitable computer readable medium, for example a non-transitory computer-readable medium, such as read-only memory, random access memory, CD-ROMs, DVDs, Blue-rays, magnetic tape, hard disk drives, solid state drives and optical drives. The computer-readable medium may be distributed over network-coupled computer systems so that the computer readable instructions are stored and executed in a distributed way.

Each of the functional modules/units described above and represented in the figures may be implemented by software, hardware or a combination of software and hardware. In one particular example, any one or more of the functional modules/units may comprise, or make use of, a trained neural network or artificial intelligence in order to perform the functionality described above. Furthermore, apparatus/system is described as a series of functional modules/units only for the sake of understanding and clarity. In practice, the functionality of any or all of the functional modules/units may be combined, and conversely the functionality of any one of the functional modules/units may alternatively be split across two or more modules/units.

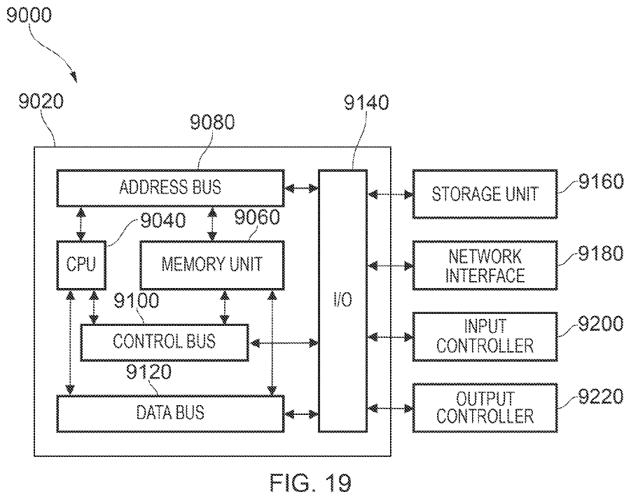

FIG. 19 shows a non-limiting example of an electronic device suitable for performing any of the above described aspects of the present disclosure. FIG. 15 shows a block diagram of an example computing system.

A computing system 9000 can be configured to perform any of the operations disclosed herein. Computing system includes one or more computing device(s) 9020. The one or more computing device(s) 9020 of the computing system 9000 comprise one or more processors 9040 and a memory 9060. The one or more processors 9040 can be any general-purpose processor(s) configured to execute a set of instructions (i.e., a set of executable instructions). For example, the one or more processors 9040 can be one or more general-purpose processors, one or more field programmable gate array (FPGA), and/or one or more application specific integrated circuits (ASIC). In one example, the one or more processors 9040 include one processor. Alternatively, the one or more processors 9040 include a plurality of processors that are operatively connected. The one or more processors 9040 are communicatively coupled to the memory 9060 via an address bus 9080, a control bus 9100, and a data bus 9120. The memory 9060 can be a random-access memory (RAM), a read-only memory (ROM), a persistent storage device such as a hard drive, an erasable programmable read-only memory (EPROM), and/or the like. The one or more computing device(s) 9020 further comprise an I/O interface 9140 communicatively coupled to the address bus 9080, the control bus 9100, and the data bus 9120.

The memory 9060 can store information that can be accessed by the one or more processors 9040. For instance, memory 9060 (e.g., one or more non-transitory computer-readable storage mediums, memory devices) can include computer-readable instructions (not shown) that can be executed by the one or more processors 9040 in order to perform the methods/processes described herein. The computer-readable instructions can be software written in any suitable programming language or can be implemented in hardware. Additionally, or alternatively, the computer-readable instructions can be executed in logically and/or virtually separate threads on the one or more processors 9040. For example, the memory 906 can store instructions (not shown) that when executed by the one or more processors 904 cause the one or more processors 9040 to perform operations such as any of the operations and functions for which the electronic device 9000 is configured, as described herein. In addition, or alternatively, the memory 9060 can store data (not shown) that can be obtained, received, accessed, written, manipulated, created, and/or stored. In some implementations, the computing device(s) 9020 can obtain from and/or store data in one or more memory device(s) that are remote from the computing system 9000.

The computing system 9000 further comprises a storage unit 9160, a network interface 9180, an input controller 9200, and an output controller 9220. The storage unit 9160, the network interface 9180, the input controller 9200, and the output controller 9220 are communicatively coupled to the computing device(s) 9020 via the I/O interface 9140.

The storage unit 9160 is a computer readable medium, preferably a non-transitory computer readable medium or non-transitory machine readable medium, comprising one or more programs, the one or more programs comprising instructions which when executed by the one or more processors 9040 cause the computing system 9000 to perform the method steps of the present disclosure. Alternatively, the storage unit 9160 is a transitory computer readable medium. The storage unit 9160 can be a persistent storage device such as a hard drive, a cloud storage device, or any other appropriate storage device.

The network interface 9180 can be a Wi-Fi module, a network interface card, a Bluetooth module, and/or any other suitable wired or wireless communication device. In one example, the network interface 9180 is configured to connect to a network such as a local area network (LAN), or a wide area network (WAN), the Internet, or an intranet.

The skilled person will readily appreciate that various alterations or modifications may be made to the above described aspects of the disclosure without departing from the scope of the disclosure.

In each of the examples described above, the first virtual camera is automatically positioned in dependence on at least the location of the second user within the second colour video stream. In an alternative, the first user may manually set the position of the first virtual camera. For example, they may manually set it to any fixed position on their first display. Alternatively, they may manually set it to any position on the second user in the second colour video stream presented on their first display, and the system may then automatically update the position of the virtual camera as the second user moves. Alternatively, the first user may be offered one or more options for where the virtual camera is to be set, for example being offered the option of setting it to track the location of the second user's eyes on the first display, or setting it to the centre of the first display, or setting it to track the centre of a document they have open on the first display, etc. If there are three or more participants in the video communication, the first user may do this for each of the two or more users that are displayed on their first display. In one particular example, the user may be offered the option of setting one camera to automatically track one of the users visible on the first display and setting another camera to automatically track another of the users visible on the first display.

In a further alternative, the second user may set the position of the first virtual camera.

This may enable them to move the first virtual camera around manually so that they can change the view of the first scene that they are observing on their second display. This may be particularly useful, for example, in a healthcare or educational setting, where the second user needs quickly to see a different part of the first user or something else in the first scene in order to perform their job.

In each of these example alternatives for setting the position of the first virtual camera, the transform determiner 1303 may receive data indicative of the first real camera position 1310 and the location at which the virtual camera has been set. It may optionally also receive data indicative of the position of the first user 1313 and may optionally comprise the rotation determiner 1420 and/or the condition detector 1620 transformation adjuster 1630 described earlier with reference to FIGS. 14 to 16. Likewise, the system operations may be organised in any of the ways described above, for example with reference to FIGS. 17 and 18, regardless of how the position of the virtual camera is set.

1. A method for video communication between a first user and a second user, the method comprising:
receiving a first video stream comprising a first colour video made up of a first plurality of time-consecutive colour frames capturing a first scene that includes the first user, wherein the first colour video is captured by a first real camera;
receiving a second video stream comprising a second colour video made up of a second plurality of time-consecutive colour frames capturing a second scene that includes the second user, wherein the second colour video is captured by a second real camera;
setting a position of a first virtual camera based on:
a location on a first display at which the second colour video is displayed to the first user; and
a location of the second user within a second current colour frame of the second plurality of time-consecutive colour frames;
generating a first transformed colour frame using a first current colour frame of the first plurality of time-consecutive colour frames, wherein the first transformed colour frame appears to capture the first scene from the position of the first virtual camera; and
outputting the first transformed colour frame for display to the second user.

2. The method of claim 1, wherein setting the position of the first virtual camera comprises:
determining a location of an image of the second user on the first display; and
setting the virtual camera based on the determined location.

3. The method of claim 1, wherein setting the position of the first virtual camera is further based on a 3D position of the second user relative to a location on a second display at which the first transformed colour frame will be displayed to the second user.

4. The method of claim 3, wherein setting the position of the first virtual camera comprises:
determining the 3D position of the second user relative to the location at which the first transformed colour frame will be displayed on the second display using:
the location of the second user within the second current colour frame;
a depth of the second user from the second camera;
the location at which the first transformed colour frame will be displayed on the second display; and
a known position of the second real camera relative to the second display; and
setting the position of the first virtual camera using:
the location on the first display at which the second colour video is displayed to the first user; and
the determined 3D position of the second user relative to the location at which the first transformed colour frame will be displayed on the second display.

5. The method of claim 3, wherein the first virtual camera is set at a 3D position that is behind the first display.

6. (canceled)

7. The method of claim 3, wherein setting the position of the first virtual camera is further based on a matrix defining a relationship between the location of the first user within the first scene captured by first video stream and the location of the second user within the second scene captured by the second video stream.

8. (canceled)

9. The method of claim 3, wherein the method further comprises:
setting a field of view of the first virtual camera based on:
the 3D position of the second user relative to the location at which the first transformed colour frame will be displayed on the second display; and
a size at which the first transformed colour frame will be displayed on the second display.

10. The method of claim 1, wherein the position of the first virtual camera comprises:
a location in 3D and at least one of:
a rotation of the first virtual camera around at least one axis;
a principle point of the first virtual camera.

11. The method of claim 1, wherein the first transformed colour frame is generated such that a location of the first user in the first transformed colour frame matches a location of the first user in the first current colour frame.

12. The method of claim 11, further comprising:
setting a rotation of the first virtual camera so that the location of the first user in the first transformed colour frame matches the location of the first user in the first current colour frame.

13. The method of claim 1, wherein setting the position of the first virtual camera is further based on a location of the second user within at least one preceding frame of the second plurality of time-consecutive colour frames, wherein the at least one preceding frame precedes the second current colour frame in the second plurality of time-consecutive colour frames.

14. The method of claim 1, further comprising, responsive to a change in the location of the second colour video on the first display:
setting an updated position of the first virtual camera based on:
a new location of the second colour video on the first display; and
the location of the second user within the second current colour frame.

15. (canceled)

16. The method of claim 1, further comprising:
determining, based on the image content of the first current colour frame, whether at least one transformation adjustment condition is met; and
if a transformation adjustment condition is met:
adjusting the transformation applied to the first current colour frame in order to generate of the first transformed colour frame.

17. The method of claim 16, wherein the at least one transformation adjustment condition comprises a pose condition, and wherein determining whether the pose condition is met comprises:
determining a pose of the first user in the first current colour frame, wherein the pose comprises measures of pose in at least two dimensions; and
if the magnitude of the determined pose is greater than a disablement threshold, the pose condition is met and the transformation is adjusted by disabling at least part of the transformation.

18-23. (canceled)

24. The method of claim 1, wherein the video communication between the first user and the second user comprises data communication between a first electronic device associated with the first user and a second electronic device associated with the second user, and
wherein at least part of generating the first transformed colour frame is performed on the second electronic device.

25. The method of claim 24, wherein data communication from the first electronic device to the second electronic device comprises the first video stream and data indicative of the location on the first display at which the second colour video is displayed relative to the position of the first real camera the first user.

26. The method of claim 24, wherein data communication from the first electronic device to the second electronic device comprises a first current depth frame corresponding to the first current colour frame, wherein the first current depth frame is indicative of a depth at least part of the first scene from the first real camera.

27. (canceled)

28. The method of claim 1, wherein the video communication is between the first user, the second user and a further user, the method further comprising:
receiving a further video stream comprising a further colour video made up of a further plurality of time-consecutive colour frames capturing a further scene that includes the further user, wherein the further colour video is captured by a further real camera;
setting a position of a further virtual camera based on:
a location on the first display at which the further colour video is displayed to the first user; and
a location of the further user within a further current colour frame of the further plurality of time-consecutive colour frames;
generating a further transformed colour frame using the first current colour frame, wherein the further transformed colour frame appears to capture the first scene from the position of the further virtual camera; and
outputting the further transformed colour frame for display to the further user.

29-33. (canceled)

34. A computer-readable medium comprising computer executable instructions stored thereon, which when executed by one or more processors, cause the one or more processors to perform the method according to claim 1.

35. An electronic device configured to perform the method of claim 1.
